(19) United States
(12) Patent Application Publication
(10) Pub. No.: US 2006/0074708 A1
(43) Pub. Date: Apr. 6, 2006

(54) Methods for grouping and maintaining low liability risk professionals

(76) Inventor: Michael S. Woods, Pipersville, PA (US)

Correspondence Address: CHARLES N. QUINN;FOX ROTHSCHILD LLP, 2000 MARKET STREET, 10TH FLOOR, PHILADELPHIA, PA, 19103, US

(21) Appl. No.: 10/326,854

(22) Filed: Dec. 20, 2002

Related U.S. Application Data
(60) Provisional application No. 60/343,348, filed on Dec. 20, 2001.

(51) Int. Cl. G06Q 10/00; G06Q 99/00

(52) U.S. Cl. 705/2; 705/1

(57) ABSTRACT

A method for assembling and dynamically maintaining a group of professionals having relatively low probability of being charged with professional malpractice using a standardized customer satisfaction survey by monitoring customer satisfaction for such candidate member of the group over a period of time to evaluate and document the predominant satisfaction that the candidate group member is achieving with patients, categorizing the predominant satisfaction for such candidate group member over time as high or low, and if the candidate has a high predominant customer satisfaction over the time period, admitting the candidate to the group and thereafter periodically repeatedly monitoring customer satisfaction for such candidate and maintaining the candidate in the group so long as the candidate evaluates as having high predominate satisfaction.

### CROSS-REFERENCE TO RELATED PATENT APPLICATION

This application claims the benefit of U.S. provisional patent application Ser. No. 60/343,348 filed Dec. 20, 2001 entitled “Method For Grouping and Maintaining Low Liability Risk Professionals” under 35 USC 119(e), the disclosure of which is incorporated herein by reference.

### BACKGROUND OF THE INVENTION

1. Field of the Invention

This invention relates principally to electronic and interactive, in some cased Internet based, methods for evaluating and assembling groups of professionals having low risk of being charged with professional malpractice and thereafter maintaining those groups during the course of their professional practice, all desirably using the Internet.

2. Description of the Prior Art

Psychologists have noted that there are four key groups for any organization in which results must be obtained. These are the employees, the customers, the organization and the stake-holders in the organization. See Results-Based Leadership by Ulrich, Zenger & Smallwood, Harvard Business School Press, Boston, Mass., copyright 1999. Obtaining results or value begins with the leader who directly impacts the value employees perceive they obtain from their job. Such value perceived by the employees in turn impacts the value customers perceive they are obtaining from the organization's employees with whom those customers deal, which in turn translates into value for the organization in the form of enhanced goodwill.

Additionally, the value each of these groups perceives as being obtained from the organization serves as either a leading or a lagging, usually linear, indicator of results and value others of the groups perceive they are obtaining. Value perceived by employees as being gained in the course of doing their jobs tends to be predictive of value perceived by customers which in turn translates into goodwill or illwill for the organization, thereby affecting the value held by stake-holders in the organization. Specifically, if employees feel they are well cared for, fully rewarded and valued by the organization, the employees tend to be satisfied, to be motivated and to treat customers well. Conversely, if employees perceive they are verbally abused, underappreciated, overworked and/or underpaid, those employees interaction with customers will reflect such employee perception of their shabby treatment by the employer. If the leader of the organization acts in a way resulting in employee dissatisfaction and unhappiness, customer satisfaction and goodwill inevitably turn to dissatisfaction and illwill as a result of interaction between the customer and the disgruntled employees.

This principle is referred to as the “leadership value chain” and has been clearly demonstrated. For every 5% increase in employee satisfaction occurring as a result of leadership training of middle managers in a retail organization, there is a 1.3% improvement in customer satisfaction. See Surfing the Edge of Chaos by Pascale, Millemann and Gioja, Crown Publishing Co., New York, N.Y., Copyright 2000. The 1.3% improvement in retail customer satisfaction correlates highly with retail customer retention and increased retail sales volume, resulting in a 0.5% increase in per store revenue. The reported improvement in revenue occurred in just three calendar quarters from the initial documented improvement in employee satisfaction after the middle manager leadership training.

Leadership and interpersonal skill training in business, non-profit institutions and government has heretofore focused on establishing or enhancing the effectiveness of teams of individuals, ultimately to improve customer satisfaction. However, leadership training, interpersonal skill training and the like have not been recognized or discovered to be useful in identifying, much less managing, risk in professions such as health care and law, where liability is problematic.

The current state of the medical malpractice industry and standard risk management approaches are depicted schematically in FIG. 1. As illustrated, there are three components to most malpractice risk management programs. The first component is continuing medical education, providing elective or mandatory education to physicians. Mandatory continuing medical education typically covers issues such as disease management, new therapies, new technologies and practice risk management, which involves record-keeping and enhanced physician-patient communication techniques.

Medical malpractice insurance premiums constitute a second component of current medical professional liability risk management programs. The threat of having a higher premium increases if a physician has had to settle a malpractice claim made against him or if a judgment had been entered against the physician for malpractice.

The third component of current medical professional liability risk management programs is practice management support, which seeks to minimize medical error and to standardize therapies, typically by providing clinical algorithms for treatment of disease.

The insurance industry readily concedes that current risk management programs have not achieved the goal of controlling or reducing physician professional liability exposure. On an average basis in the United States, for every one-hundred (100) physicians, there are seventeen (17) claims for medical malpractice made annually; that number is rising. Basic limits coverage in the United States averages $42,000 per physician and is increasing. The median jury award in a malpractice action on a national basis was $500,000.00 in 1997, $750,000.00 in 1998 and $800,000.00 in 1999. Statistically, in the United States 1 in every 6 claims for medical malpractice was settled for over one-half million dollars in 1998; 5% of all claims were settled for over $1 million. From 1999 to 2000, the number of $1 million lawsuits filed and settled increased from 100 to 150 nationally. During the same period, the number of suits settled for over $3 million doubled and some settlements exceeded $10 million.

The insurance industry in the United States has not been able to stem the tide of increasing professional, specifically medical, malpractice costs with the current approach to risk management. Tort reform, which has become law in many states, has not had a dramatic impact on the costs of professional liability insurance. Indeed, the number of professional liability claims filed continues to increase. While total dollar amounts per claim may have statutory upper limits for punitive damages or damages for pain and suffering, the total amount paid each year by insurance companies to claimants continues to climb.

Continuing professional education, specifically continuing medical education, has not been demonstrated to alter physician behavior or to improve patient satisfaction or to reduce malpractice exposure liability. A study examining the effect of compulsory continuing medical education for physicians found no major changes in patient care, frequency of malpractice suits or reduction in healthcare costs growing out of compulsory continuing medical education. See Mandatory Continuing Medical Education Revisited by Stross & Harlan, Mobius 1987.

Other than promoting tort reform, physicians as a profession have failed to effectively address the malpractice issue by taking any meaningful action to correct the mounting liability problem. Peer review, which was supposed to assist in policing the profession, increasing patient safety and reducing malpractice liability, has not been successful in meeting any of these goals.

### SUMMARY OF THE INVENTION

In one of its aspects, this invention provides methods for assembling groups of professionals, preferably electronically and most preferably using the Internet, having substantially lower probability of being charged with professional malpractice, using standardized and/or proprietary customer satisfaction surveys, standardized and/or proprietary cognitive and behavioral profiling techniques and proprietary behavioral modification techniques or leadership education, to identify professionals having substantially lower probability of being charged with professional malpractice and, in some cases, to modify the behavior of professionals having an excessively high probability of being charged with professional malpractice in order to include such professionals in such groups. In one of its aspects, the invention involves use of standardized or proprietary customer satisfaction surveys, standardized proprietary cognitive and behavioral profiling and behavioral modification techniques and leadership education to methodically collect, track and analyze behavioral data in order to most effectively identify professionals having substantially lower probability of being charged with professional malpractice, thereby reducing expected professional liability claims.

In the course of practice of one aspect of the invention, inventive surveys are preferably used to link customer or patient satisfaction to individual professionals, typically physicians, or to groups of such professionals, again typically physicians. Monitoring the satisfaction of customers, typically patients, allows identification of potential high risk professionals, namely physicians, relative to customer, typically patient, satisfaction thereby permitting the formulator (of the group of desirably low risk professionals) to target an individual professional, namely a physician identified to present a higher risk, for cognitive and behavioral profiling and/or participating in a behavioral change program focusing on personal leadership and interpersonal skills so that such individual may qualify as presenting a lower risk.

In the course of practice of the invention there is preferably further involved use of standardized and/or proprietary cognitive and behavioral profiling to characterize an individual professional's liability risk prior to including the individual in the group. This is preferably done by comparing the individual's cognitive and behavioral profiles to specific, defined, validated high risk profiles based on groups known to be of high risk compared to groups of individuals known to be of low risk for liability exposure. Such standardized or proprietary cognitive behavioral profiling further allows characterization of professionals who may already be included in the group so that the group organizer may understand the risk profile of the current population of the group compared to a defined, validated, high-risk profile.

In the course of practice of additional aspects of the invention, the methods preferably further involve practice of behavioral modification techniques and leadership education. The behavioral modification techniques preferably involve 360 degree inventory and feedback approaches. The leadership education preferably involves live, printed and electronic media delivering education to the participants.

This invention is further premised on the finding that such customer satisfaction surveys and proprietary and/or standardized cognitive behavioral profiling may be used to select intrinsically motivated students for admission into professional schools in a manner that the schools may select candidates for admission based on positive-deviant cognitive behavioral profiles for intrinsically motivated individuals within a given profession, resulting in reduced liability risk for the profession over time, as such selected candidates complete their schooling and enter into the profession.

In another one of its aspects this invention provides a method for assembling and dynamically maintaining a group of professionals having a relatively low probability of being charged with professional malpractice where the method includes, for each candidate member of the group to be assembled, using a standardized or proprietary customer survey tool and monitoring customer satisfaction, for such candidate member of the group preferably for a period of time, to evaluate and document the predominant satisfaction the candidate group member achieves with customers. The predominant satisfaction for each candidate group member over time is preferably categorized as high or low. If a given candidate is evaluated to have a predominantly high customer satisfaction over the time period, the candidate is admitted into the group. Thereafter, forward-going customer satisfaction achieved by such candidate is periodically monitored. The candidate is maintained in the group so long as the candidate maintains predominately high customer satisfaction over a period of time.

In another of its aspects, this invention preferably provides a method for screening candidates for admission to professional school in order to produce an incoming class preferably having minimal risk of incurring professional liability upon graduating from the school and undertaking professional practice where the method preferably includes, for each candidate student otherwise exhibiting credentials appearing to merit acceptance for admission to the professional school of interest, preferably subjecting the candidate to proprietary standardized cognitive and behavioral profiling in order to identify the candidate's cognitive, behavioral and motivational profile. If the candidate has a high intrinsic motivational profile towards such professional study and towards satisfaction of customers for the profession's services, as found and confirmed by the standardized proprietary cognitive and behavioral profiling, then the method proceeds by admitting the candidate to the professional school. Otherwise, the method preferably proceeds by conditionally admitting the candidate to the professional school and thereafter requiring the candidate to undergo behavioral modification risk training or leadership education as defined herein. Upon successful completion of the behavioral modification risk training or the leadership education, the method preferably proceeds by lifting the condition on the candidate's admission to the professional school.

### BRIEF DESCRIPTION OF THE DRAWINGS

FIG. 1 is a block diagram representation of the risk management method currently utilized in the health care profession.

FIG. 2 is a block diagram representation of an overall evidence-based risk management method in accordance with a preferred practice of this invention.

FIG. 3 is a block diagram representation of a method for using a customer satisfaction survey in an evidence-based risk management process in accordance with the invention.

FIG. 4 is a block diagram representation of a method for using a validated cognitive behavioral profile for use in an evidence-based risk management method in accordance with the invention using standardized or proprietary cognitive behavioral profiling.

FIG. 5 is a block diagram representation of a method for using a validated cognitive behavioral profile to identify individuals as being of high or low liability exposure risk in an evidence-based risk management method in accordance with the invention utilizing standardized cognitive proprietary behavioral profiling.

FIG. 6 is a block diagram representation of a method for developing, validating and using a validated cognitive behavioral profile to select students for admission into professional schools using standardized or proprietary cognitive behavioral profiling, in accordance with aspects of this invention.

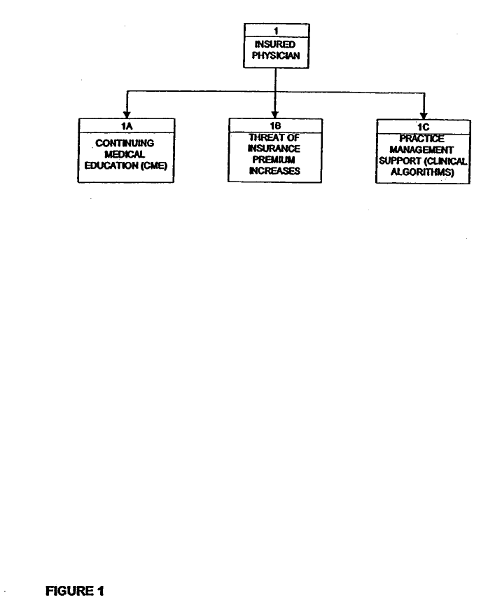

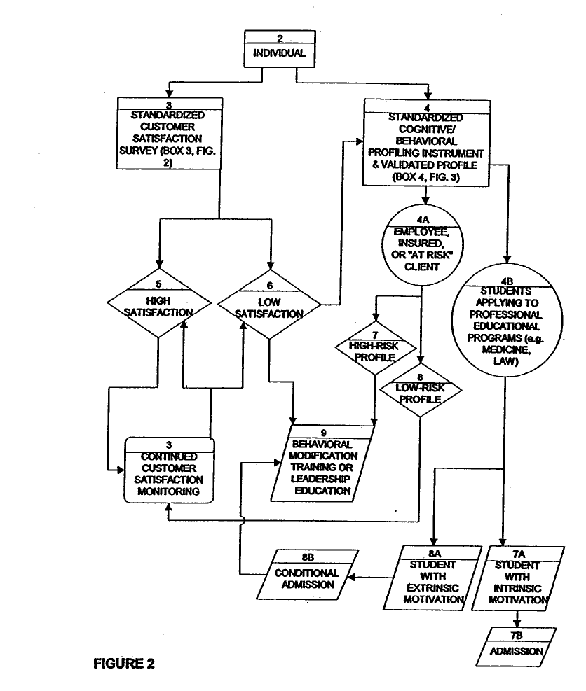

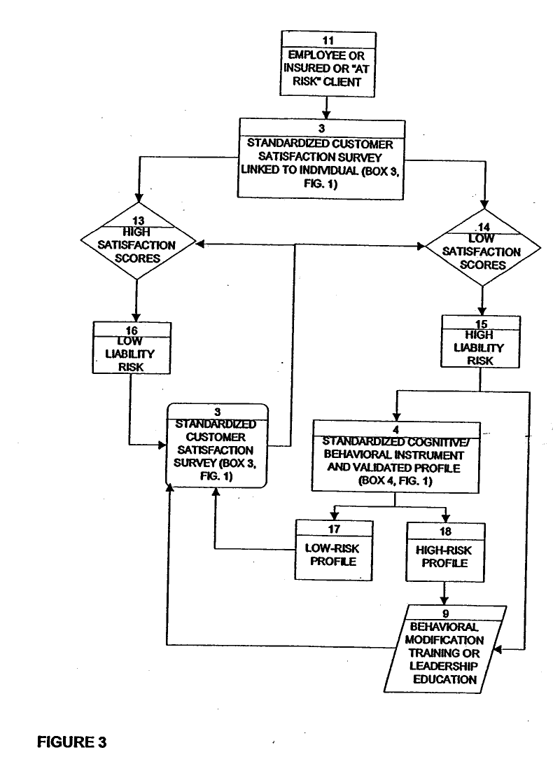

Screens A1 and A2 depict presentations appearing on a video screen of a computer or other terminal device when a customer or patient is participating in an electronic telecommunicatively-based customer satisfaction survey, preferably conducted via the Internet, as part of an evaluation of an individual seeking acceptance as a member or seeking to continue as a member of a group of professionals having a low likelihood of having a professional liability claim made against them.

Card 1 depicts a card furnished to a customer or patient is participating in a telephone-based customer satisfaction survey as part of an evaluation of an individual seeking acceptance as a member or seeking to continue as a member of a group of professionals having a low likelihood of having a professional liability claim made against them.

Screens B-1 through B5 depict presentations appearing on a video screen of a computer or other terminal device when a person is participating in an electronic telecommunicatively-based behavioral profile generation, preferably conducted via the Internet, in accordance with the methods of the invention.

Screens C1 through C5 depict presentations appearing on a video screen of a computer or other terminal device when a person is participating in an electronic telecommunicatively-based evaluation of an individual, preferably conducted via the Internet, who has completed either behavioral modification training and/or leadership training, to determine whether the acceptably modified behavior remains evident and/or whether the desirable developed leadership traits remain manifest in the individual.

### DESCRIPTION OF THE PREFERRED EMBODIMENTS AND BEST MODES KNOWN FOR PRACTICE OF THE INVENTION

Blocks on the drawings are numbered. When a block appears on different drawings, the number is consistent with the first number assigned and denotes that the step or procedure initially associated with or represented by the box remains consistent through all of the drawing figures.

As used herein, leadership attributes are behaviors, and are defined in behavioral terms, which are assessed accurately through 360-degree feedback mechanisms or techniques as described by David Ulrich, Jack Zenger, and Norm Smallwood in Results-based Leadership. Harvard Business School Press, Boston. Copyright 1999, pp. 14-15. Information provided by 360-degree feedback mechanisms is utilized to assist individuals in modifying their behavior, resulting in enhanced leadership skills.

Another mechanism or technique to assist individuals in changing or enhancing their leadership behaviors is preferably proprietary leadership education, utilizing materials that educate the person about leadership attributes necessary to be effective as an individual. Such attributes focus primarily on enhancing and demonstrating personal character, including being personally trustworthy and having integrity, moral honesty, intellectual honesty, respect for the individual and self-awareness. Developing such attributes enhances personal leadership ability, and can be used to modify and improve an individual's behavior. Leadership education enhances attributes an individual currently has and/or assists in providing insight to individuals for subsequent development. Such leadership educational materials may use printed (e.g. books, articles, journals, manuals), electronic (e.g. computer, Internet e-learning, video and/or audio), or live (e.g. verbal) formats.

One proprietary customer satisfaction survey which is highly suitable and is preferred for use in practice of the invention is available from the Woods Development Institute in Pipersville, Pa. This Woods Development Institute customer satisfaction survey, in the version used to evaluate a physician's level of customer satisfaction, utilizes a series of statements relating to the physician's office and to the physician. The statements pertaining to the physician's office seek to ascertain satisfaction of patients with the physician's office and office environment while the statements pertaining to the physician seek to elicit the level of patent satisfaction with the care rendered by the physician. The survey ascertains how patients currently view their physician's office and staff and how the patients view their physician's performance relative to the patient's healthcare.

Table 1 sets forth exemplary ones of the Woods Development Institute customer proprietary satisfaction survey statements for both the office and physician. Table 2 sets forth the permissible responses. The statements from Table 1 are preferably presented as a group of statements to each respondent being surveyed. Each respondent is requested to respond to each of the statements by providing one of the six responses set forth in Table 2 for each of the statements appearing in Table 1.

After the relevant population is surveyed, a summary score is calculated for all of the inquiries relating to the physician's office and the totals are represented by the word “All” in Diagram 1. Summaries of responses for individual inquiries, which are identified by italicized parentheticals in Table 1, appear in Diagrams 1 and 2.

For the exemplary physician patient satisfaction survey results illustrated in Diagrams 1 and 2, the survey was conducted utilizing seventy-eight (78) adult respondent-patients replying to one hundred sixty-one (161) distributed surveys. Of the respondents thirty-six percent (36%) were male, fifty-five percent (55%) were female while the gender of nine percent (9%) of the respondents was not known. The demonstrated higher response rate in females is believed usual for surveys since women tend to have a higher response rate than men. Age range of the respondents was from twenty-five (25) to seventy-four (74) years. A specific ethnic break-down is not available, but it is know that African Americans, Asians, Hispanics and Caucasians participated in this survey, with the population being highly skewed towards Caucasian. Educational backgrounds ranged from high school to doctorate degrees.

The zero points of Diagrams 1 and 2 correlate with the highly dissatisfied or strongly disagree region or end of the scaled permissible responses presented in Table 2 while the 100% points in Diagrams 1 and 2 correlate with the highly satisfied or strongly agree region or end of the scaled permissible responses presented in Table 2.

In the proprietary Woods Development Institute customer survey, like most customer surveys, a satisfaction rating by a customer of less than 90%, in an area of interest with the customer rating indicated being at least somewhat dissatisfied with the service of interest, is unacceptable. Hence, a physician receiving a rating of less than 90% of the respondents as being at least somewhat satisfied in any of the italicized inquiry areas set forth in Table 1, where the results appear in Diagrams 1 and 2, would not qualify as representing acceptably high customer satisfaction, in performing the various steps of the methods of the invention using the Woods Development Institute customer survey.

A highly suitable cognitive behavioral inventory tool for producing a validated profile of an individual's behavior and which is preferred for use in practicing the invention is produced by Etest and is available at www.etest.net. The complete Etest assessment battery is composed of a reasoning skills test, a vocabulary test and a personality inventory. The result provided after a candidate completes the assessment battery is a personality profile presenting scores on scales of 1 through 10 of various personality aspects or traits of the individual. The profile for the individual is presented together with central tendency data for people performing successfully in a particular job of interest.

In the examples presented herein the job is that of a physician, in accordance with the preferred practice of the invention.

The subject's Etest personality profile is preferably developed by presentation of a series of adjectives, five (5) at one time, to the subject. The subject is asked to indicate how well each of the adjectives describes himself or herself, where the choices available to the subject are that he or she (i) strongly agrees, (ii) agrees, (iii) is neutral or unsure, (iv) disagrees or (v) strongly disagrees with the premise that the adjective describes him or herself. Examplary presentations of groups of five (5) word adjectives preferably used in administering the E-test are presented below as Table 3.

An exemplary personality profile for one person developed from responses to the respective successively presented groups of adjectives is presented as Table 4.

Once the personality profile has been developed for a particular subject, the particular subject's profile is compared to profiles for successful people in the particular profession of interest, which in the preferred practice of the invention is medicine. The comparison of the subject's profile with the profiles of persons who have been demonstrably successful in the profession and the determination of the amount of deviation of the subject's profile from one or more profiles constructed from the average or median scores of persons who have been successful in the profession indicates whether the subject individual is of low risk or high risk, in accordance with the practice of the invention.

One suitable testing program to determine whether required behavioral modification training or leadership education has been successful with respect to a subject of interest, which is preferred for use in practice of the invention, is the LeadRx personal development program available from The Woods Development Institute in Pipersville, Pa. This personal development program, in a version used to evaluate whether a physician has successfully modified his or her behavior as a result of behavioral modification training and/or has increased his or her leadership ability as a result of leadership education, utilizes a series of statements which are divided into seven (7) categories. An exemplary set of the statements, divided into the seven (7) categories, appears in Table 5. Each set of statements under a given heading seeks to elicit responses from the survey participant respecting the physician's behavior and behavioral pattern and leadership characteristics in the given category. For example, in the category inquiring as to whether the physician seeks win-win solutions, the first question is whether the survey participant perceives the physician as striving for win-win relationships.

For each physician who is subject of the inquiry as to whether the required behavioral modification training or leadership education has been successful, statements such as those set forth in Table 5 are presented to the physician as well as to the physician's partners, supervisors (if any), nurses and office staff members. Each participant in the survey is asked to respond to each statement appearing in Table 5 for the physician of interest by indicating one of the five choices presented in Table 6 as being the appropriate choice or response for the statement of interest as applied to the physician.

### PROPHETIC EXAMPLE 1 FOR FIG. 2

A candidate for inclusion as a member of a group of physicians having relatively low probability of being charged with medical malpractice is preliminarily identified. For that candidate, satisfaction of that physician's patients over a period of time is monitored preferably via the Internet or other interactive electronic telecommunication means and documented. Using suitable tools, most preferably The Woods Development Institute customer survey version for physicians, the predominant patient satisfaction level the physician achieves with his patients is determined, most preferably via the Internet or other interactive electronic telecommunication means. The resulting satisfaction level compared to predetermined criteria is characterized as high. As a result, the physician is initially included as a member of the group of physicians having relatively low probability of being charged with medical malpractice. This member of the group, like all members of the group, is thereafter monitored, preferably via the Internet or other interactive electronic telecommunication means, as to the satisfaction of patients over forward-going time periods and patient satisfaction level is compared to the predetermined criteria preferably via the Internet or other interactive electronic telecommunication means. So long as the satisfaction level of the physician's patients remains high according to the predetermined criteria, the physician is retained as a member of the group.

### PROPHETIC EXAMPLE 2 FOR FIG. 2

A candidate for inclusion as a member of a group of physicians having relatively low probability of being charged with medical malpractice is preliminarily identified. The satisfaction of that candidate's patients over a period of time is monitored preferably via the Internet or other interactive electronic telecommunication means and documented. Using suitable tools, most preferably The Woods Development Institute customer survey version for physicians, the predominant patient satisfaction level the physician achieves with his patients is determined, compared to predetermined criteria and is categorized as low. As a result, the physician is initially excluded from membership in the group of physicians having relatively low probability of being charged with medical malpractice; the physician is identified as possibly representing a high liability risk. This candidate member of the physician group is thereafter presented with the option of undergoing standardized cognitive behavioral profiling preferably via the Internet or other interactive electronic telecommunication means to identify and better understand the candidate's cognitive and behavioral profile or to participate in preferably proprietary either behavioral modification training preferably via the Internet or other interactive electronic telecommunication means or leadership education preferably via the Internet or other interactive electronic telecommunication means.

If the candidate elects to undergo either standardized or preferably proprietary cognitive behavioral profiling preferably via the Internet or other interactive electronic telecommunication means and a low risk profile score results, the candidate is admitted to the group.

If the candidate elects to undergo either standardized or preferably proprietary cognitive behavioral profiling preferably via the Internet or other interactive electronic telecommunication means and a high-risk profile is confirmed, the candidate is initially excluded from membership in the group of physicians having relatively low probability of being charged with malpractice and is asked to undergo either preferably proprietary behavioral modification training or preferably proprietary leadership education preferably via the Internet or other interactive electronic telecommunication means, with the candidate making the selection between the two. Upon electing one of the two and completing the elected course, patient satisfaction is again monitored preferably via the Internet or other interactive electronic telecommunication means as to satisfaction of that physician's patients over forward-going time periods. The patient satisfaction levels are compared to predetermined criteria. If the satisfaction level of the candidate-physician's patients is then high according to the predetermined criteria, the candidate physician is admitted as a member of the group. This new member of the group, like all members of the group, is thereafter monitored preferably via the Internet or other interactive electronic telecommunication means as to the satisfaction of patients over forward-going time periods and the patent satisfaction level is compared to predetermined criteria.

However, if the satisfaction level of the physician's patients remains low compared to predetermined criteria over the forward-going time period(s), the candidate-physician again is presented with the option preferably via the Internet or other interactive electronic telecommunication means to repeat either standardized or preferably proprietary cognitive behavioral profiling preferably via the Internet or other interactive electronic telecommunication means to again identify and better understand the candidate's cognitive and behavioral profile or to undergo additional preferably proprietary behavior modification training or preferably proprietary leadership education preferably via the Internet or other interactive electronic telecommunication means.

If the candidate elects to repeat either standardized or preferably proprietary cognitive behavioral profiling and if the resulting profile is of low risk, the candidate is accepted into the group and patient satisfaction monitoring of that candidates' patients goes forward, just as it does with the other group members. However, if the candidate elects to repeat either standardized or preferably proprietary cognitive behavioral profiling preferably via the Internet or other interactive electronic telecommunication means and the resulting profile is one of high risk, then the candidate is again presented with the choice of undergoing preferably proprietary behavioral modification training or preferably proprietary leadership education preferably via the Internet or other interactive electronic telecommunication means and to continue and complete the chosen course and thereafter to continue with customer satisfaction monitoring preferably via the Internet or other interactive electronic telecommunication means.

These behavioral profiling/patient satisfaction monitoring/candidate training/education steps of the process are repeated preferably via the Internet or other interactive electronic telecommunication means until either the candidate qualifies for the low risk group as a result of high patient satisfaction scores or the process is terminated and the candidate is rejected for membership in the group.

### PROPHETIC EXAMPLE 3 FOR FIG. 2

A candidate for inclusion as a member of a group of physicians having relatively low probability of being charged with medical malpractice is preliminarily identified. Satisfaction of that candidate's patients over a period of time is monitored and documented preferably via the Internet or other interactive electronic telecommunication means. Using suitable tools, most preferably the Wood Development Institute customer survey version for physicians, the predominant patient satisfaction level the physician achieves with his patients is determined, compared to predetermined criteria and is categorized as low. As a result, the physician is initially excluded from membership in the group of physicians having relatively low probability of being charged with medical malpractice; the physician is identified as possibly representing a high liability risk. This candidate member of the physician group is thereafter presented with the option of undergoing standardized or preferably proprietary cognitive behavioral profiling preferably via the Internet or other interactive electronic telecommunication means to identify and better understand the candidate's cognitive and behavioral profile or to participate in either preferably proprietary behavioral modification training or preferably leadership education preferably via the Internet or other interactive electronic telecommunication means.

If the candidate elects either standardized or proprietary cognitive behavioral profiling and a low risk profile score results, the candidate is admitted to the group.

### PROPHETIC EXAMPLE 4 FOR FIG. 2

A candidate for inclusion as a member of a group of physicians having relatively low probability of being charged with medical malpractice is preliminarily identified. The satisfaction of that candidate's patients over a period of time is monitored and documented preferably via the Internet or other interactive electronic telecommunication means. Using suitable tools, most preferably the Woods Development Institute customer version for physicians, the predominant patient satisfaction level the physician achieves with his patients is determined, compared to predetermined criteria and categorized as low. As a result, the physician is initially excluded from membership in the group of physicians having relatively low probability of being charged with medical malpractice; the physician is identified as possibly representing a high liability risk. This candidate member of the physician group is thereafter presented with the option of undergoing either standardized or proprietary cognitive behavioral profiling preferably via the Internet or other interactive electronic telecommunication means to identify and better understand the candidate's cognitive and behavioral profile or to participate in either preferably proprietary behavioral modification training or preferably proprietary leadership education preferably via the Internet or other interactive electronic telecommunication means.

The candidate elects standardized or proprietary cognitive behavioral profiling preferably via the Internet or other interactive electronic telecommunication means and a high-risk profile results. The candidate is then asked to undergo either preferably proprietary behavioral modification training or preferably proprietary leadership education preferably via the Internet or other interactive electronic telecommunication means, with the candidate making the election between the two. Upon electing preferably proprietary behavioral modification training and completing the elected course of instruction and therapy preferably via the Internet or other interactive electronic telecommunication means, patient satisfaction is again monitored as to satisfaction of that physician's patients over forward-going time periods. The patient satisfaction levels are compared to predetermined criteria. If the satisfaction level of the candidate's patients is then high according to the predetermined criteria, the candidate is admitted as a member of the group. This new member of the group, like all members of the group, is thereafter monitored preferably via the Internet or other interactive electronic telecommunication means as to the satisfaction of patients over forward-going time periods and the patent satisfaction level is compared to predetermined criteria.

### PROPHETIC EXAMPLE 6 FOR FIG. 2

A candidate appearing to be acceptable for admission to medical school and intending after graduation to become a member of a group of physicians having relatively low probability of being charged with medical malpractice is preliminarily identified. The candidate is subjected to standardized or proprietary cognitive behavioral profiling preferably via the Internet or other interactive electronic telecommunication means to identify and better understand the candidate's cognitive behavioral motivational profile. If a high intrinsic motivational profile towards the study of medicine and patient satisfaction is confirmed, the candidate is admitted to the medical school.

### PROPHETIC EXAMPLE 7 FOR FIG. 2

A candidate appearing to be acceptable for admission to medical school and intending after graduation to become a member of a group of physicians having relatively low probability of being charged with medical malpractice is preliminarily identified. The candidate is subjected to standardized or proprietary cognitive behavioral profiling preferably via the Internet or other interactive electronic telecommunication means to identify and better understand the candidate's cognitive behavioral motivational profile. If a low intrinsic motivational profile towards the study of medicine and patient satisfaction is confirmed, the candidate is conditionally admitted to medical school. This candidate is thereafter required to undergo behavioral modification risk training. Upon successful completion of the same the condition on the candidate's admission to medical school is lifted.

### PROPHETIC EXAMPLE 8 FOR FIG. 2

A candidate appearing to be acceptable for admission to medical school and intending after graduation to become a member of a group of physicians having relatively low probability of being charged with medical malpractice is preliminarily identified. The candidate is subjected to proprietary or standardized cognitive behavioral profiling preferably via the Internet or other interactive electronic telecommunication means to identify and better understand the candidate's cognitive behavioral motivational profile. If a low intrinsic motivational profile towards the study of medicine and patient satisfaction is confirmed, the candidate is conditionally admitted to medical school. This candidate is thereafter required to undergo leadership education preferably via the Internet or other interactive electronic telecommunication means. Upon successful completion of the same the condition on the candidate's admission to medical school is lifted.

### PROPHETIC EXAMPLE 9 FOR FIG. 2

In the course of assembling and dynamically maintaining a group of professionals having relatively low probability of being charged with professional malpractice, a candidate member of the group is identified. Using a standardized or proprietary customer satisfaction survey, most preferably the Woods Development Institute customer survey version for physicians, customer satisfaction for such candidate member of the group is monitored preferably via the Internet or other interactive electronic telecommunication means over a period of time to evaluate and document the satisfaction the candidate group member is achieving with customers. The customer satisfaction achieved by such candidate member over time is unacceptably low. As a result of the candidate evaluating as having low customer satisfaction over time, the candidate is identified as potentially representing an unacceptably high liability risk and hence as being unqualified, based on present information, for inclusion in the group having relatively low probability of being charged with professional malpractice. The candidate is then required either to submit to proprietary or standardized cognitive behavioral profiling preferably via the Internet or other interactive electronic telecommunication means to identify the candidate's cognitive behavioral profile or to go to either proprietary behavioral modification training or proprietary leadership education and to attend the elected program preferably via the Internet or other interactive electronic telecommunication means until the forward going customer satisfaction data for such candidate reflect a low-risk profile. The candidate elects to undergo proprietary behavioral modification training preferably via the Internet or other interactive electronic telecommunication means for such time until the forward-going customer satisfaction data for such candidate reflects a low-risk profile for customer satisfaction as the candidate continues professional practice. After a sufficient time that forward-going high customer satisfaction data consistently reflects a low risk profile for the candidate, the candidate is admitted into the group.

### PROPHETIC EXAMPLE 10 FOR FIG. 2

In the course of assembling and dynamically maintaining a group of professionals having relatively low probability of being charged with professional malpractice, a candidate member of the group is identified. Using a proprietary standardized customer satisfaction survey, most preferably the Woods Development Institute customer survey version for physicians, customer satisfaction for such candidate member of the group is monitored preferably via the Internet or other interactive electronic telecommunication means over a period of time to evaluate and document the satisfaction that the candidate group member is achieving with customers. The customer satisfaction achieved by such candidate member over time is unacceptably low. As a result of the candidate evaluating as having low customer satisfaction over time, the candidate is identified as potentially representing an unacceptably high liability risk and hence as being unqualified, based on present information, for inclusion in the group having relatively low probability of being charged with professional malpractice. The candidate is then required either to submit to standardized or proprietary cognitive behavioral profiling preferably via the Internet or other interactive electronic telecommunication means to identify the candidate's cognitive/behavioral profile or to go to either preferably proprietary behavioral modification training or preferably proprietary leadership education preferably via the Internet or other interactive electronic telecommunication means and to attend until the forward going customer satisfaction data for such candidate reflect a low-risk profile. The candidate elects to undergo preferably proprietary behavioral modification training for such time until the forward-going customer satisfaction data for such candidate reflect a low-risk profile for customer satisfaction as the candidate continues professional practice. After a sufficient time for forward-going customer satisfaction data to reflect a consistent change in customer satisfaction resulting from actions by the candidate, when such data does not consistently reflect a change and hence does not reflect a new low risk profile for the candidate, the candidate is refused admission into the group.

### PROPHETIC EXAMPLE A FOR FIG. 2

A candidate seeking inclusion as a member of a group of physicians having relatively low probability of being charged with medical malpractice and hence qualifying for a reduced malpractice insurance premium contacts an insurer, which only insures physicians having a relatively low probability of being charged with malpractice. To qualify for inclusion as a member of the group of physicians having relatively low probability of being charged with medical malpractice and hence qualifying to be insured by the insurance carrier, the physician arranges for placement of an electronic terminal in the physician's offices whereby that physician's patients may be polled as to their satisfaction with a physician's services.

Once the terminal is installed, prior to a patient leaving the physician's office, the patient is requested to sit at the communications terminal and to participate in a patient satisfaction survey. After logging onto the terminal, being provided with a code to preserve the anonymity of the patient and after viewing a screen assuring the patient of confidentiality regarding the patient's responses and anonymity regarding the patient's identity, the statements appearing in Table 1 appear individually and sequentially on the computer screen. Coupled with each statement as it appears in the computer terminal screen are the permissible responses appearing in Table 2. An exemplary screen for the first statement in Table 1 is set forth as Screen A-1.

The patient touches the computer terminal screen in a spot corresponding to the selected one of the six permissible responses to the first statement appearing in Table 1, as displayed on Screen A-1. Upon the patient touching the screen and indicating which of the six permissible responses the patient has selected, the response is transmitted, preferably via the Internet, to a central computer monitoring station operated by or on behalf of the insurer, where that response is stored in a database and identified as being from the patient for the particular physician seeking inclusion as a member of the group. The screen then changes to present the second of the statements in Table 1, appearing as Screen A-2.

The process is repeated until the particular patient has cycled through all of the separate screens, one for each of the statements appearing in Table 1, and has provided one (1) of the six (6) acceptable responses for each of those statements.

As an alternative, a patient who is requested to participate in the physician satisfaction survey may elect to do so from the patient's home or elsewhere using the patient's home or other remote computer. In that case, the patient communicates via the Internet with the insurance provider or other entity. After providing the patient-participant's name, identification code and seeing a screen assuring the patient of confidentiality and anonymity with respect to use of the survey responses, the patient is presented with a series of screens, such as Screens A-1 and A-2, taking the patient through the statements appearing in Table 1 and constraining the patient to respond to each statements using one of the six permissible responses as set forth in Table 2. The screens presented to the patient appear the same as Screens A-1 and A-2; the patient sequentially indicates the patient's responses by clicking on the selected response thereby transmitting that response for the given screen to a central computer via which data for the physician of interest is collected. Once the response is submitted, the screen changes.

This Internet-based, interactive implementation of the Woods Development Institute Customer Survey for Physicians is used to collect the data from a predetermined number of the candidate physician's patients over a preselected period of time. After the required number of patients have been polled and their responses tabulated and processed, the resulting patient satisfaction level is compared to predetermined criteria; where the resulting patient satisfaction level is high relative to the predetermined criteria, the physician is deemed to be initially qualified for inclusion as a member of the group of physicians having relatively low probability being charged with medical malpractice and hence is qualified to be covered as an insured by the insurance company.

For the accepted physician, satisfaction of that physician's patients over a period of time is thereafter monitored, preferably via the Internet or other interactive electronic telecommunication means using the same procedures, equipment and techniques as described above and is documented. This physician member of the group of physicians, like all members of the group of physicians, is thereafter monitored through polling of the physician's patients, again preferably using a terminal in the physician's offices and having the physician's patients scroll through the screens presenting, on an individual basis, the statements appearing in Table 1 and constraining the patient being polled to respond using one of the six responses set forth in Table 2, with the screens again appearing as Screens A-1 and A-2 attached. Alternatively, the patient may participate in the physician satisfaction survey from the patients' homes or other remote locales using other remote terminals in the manner described above. In either case, the polling and monitoring continues as to the satisfaction of the physician's patients over forward-going time periods with this polling and monitoring being conducted, preferably via the Internet or other interactive electronic telecommunication means as described above, and with resulting patient satisfaction level being compared to the predetermined criteria. So long as the satisfaction level of the physician's patients remains high according to the predetermined criteria, the physician is retained as a member of the group.

### PROPHETIC EXAMPLE B FOR FIG. 2

A candidate seeking inclusion as a member of a group of physicians having relatively low probability of being charged with medical malpractice and hence qualifying for a reduced malpractice insurance premium contacts an insurer, which only insures physicians having a relatively low probability of being charged with malpractice. To qualify for inclusion as a member of the group of physicians having relatively low probability of being charged with medical malpractice and hence qualifying to be insured by the insurance carrier, the physician arranges for consenting patients to be contacted by a telephone survey system whereby that physician's patients having no knowledge of or perhaps even fear of computers and related software may be polled as to their satisfaction/dissatisfaction with the physician's services via the telephone in the comfort and convenience of their home.

When a patient leaves the physician's office, the patient is offered the choice of being polled immediately using an electronic computer terminal in the physician's office, using an electronic terminal at remote location as set forth in Prophetic Example A or not being polled electronically. If the patient chooses not to be polled electronically, the patient is presented with a card, such as shown in Card 1, containing the doctor's identification number and an identifying telephone number for the patient to call. On the card, the permissible responses to be chosen are listed. There is also an insertion line on the card for the patient to write a number given to them after successful completion of the survey.

As an incentive for patients to participate in the survey, the physician has previously entered into an agreement with a local merchant to offer a discount on health and beauty aid products to those patients participating in the survey. Alternatively, the physician offers free admission to a health-related seminar or discussion at the physician's office to be held at a later date.

At a convenient time, the patient calls the telephone number listed on Card 1, as given to the patient at the completion of their office visit, using a touch-tone telephone. After entering the physician identification number listed on Card 1 which was provided to the patient at the physician's office, the patient is connected to a service having a pre-recorded set of questions as set forth in Table 1. At that time, the questions set forth in Table 1 are asked of the patient, and after each question, the patient answers the question, using one of the choices set forth in Card 1 by pressing a corresponding number on the telephone key pad to indicate the patient's satisfaction or dissatisfaction with the services received at the physician's office. After satisfactorily answering all of the questions, the patient receives an identifying number. The patient writes the number on the bottom of Card 1. Thereafter, Card 1 can then be redeemed, either at the local merchant for discount products or at the physician's office for health-related counseling.

The answers provided by the patient via telephone are stored in a previously created database for the particular physician, to be collected, processed and reviewed at a later date.

This interactive implementation of the Woods Development Institute Customer Survey for Physicians is used to collect data from a predetermined number of the candidate physician's patients over a preselected period of time. After the required number of patients have been polled, the resulting satisfaction level is compared to predetermined criteria; where the resulting satisfaction level as compared to the predetermined criteria is “high”, the physician is deemed to be initially qualified for inclusion as a member of the group of physicians having relatively low probability being charged with medical malpractice and hence as qualified to be covered as an insured by the insurance company.

For the accepted physician, satisfaction of that physician's patients over a period of time is thereafter monitored by telephone means using the same procedures, equipment and techniques as described above and is documented. This physician member of the group, like all members of the physician group, is thereafter monitored through the polling of the physician's patients, again preferably a telephone survey having the physician's patients answer all the statements appearing in Table 1 and constraining the patients being polled to responding with one of the six responses set forth in Table 2. The polling and monitoring continues as to the satisfaction of patients over forward-going time periods with this polling and monitoring being conducted via telephone as described above. Resulting patient satisfaction level is compared to the predetermined criteria. So long as the satisfaction level of the physician's patients remains high according to the predetermined criteria, the physician is retained as a member of the insured physician group.

### PROPHETIC EXAMPLE C FOR FIG. 2

A candidate seeking inclusion as a member of a group of physicians having relatively low probability of being charged with medical malpractice and hence qualifying for a reduced malpractice insurance premium contacts an insurance carrier, which only insures physicians having a relatively low probability of being charged with malpractice. To qualify for inclusion as a member of the group of physicians having relatively low probability of being charged with medical malpractice and hence qualifying to be insured by the insurance carrier, the physician arranges for his consenting patients to participate in a telephone survey system whereby that physician's patients having no knowledge of computers, or perhaps having fear of computers and related software, may be polled as to their satisfaction of a physician's services via the telephone in the comfort and convenience of their homes.

In this practice of the invention, when a patient leaves the participating physician's office, the patient is offered the choice of being polled immediately at the electronic terminal in the physician's office, or using an electronic terminal at remote location as set forth in Prophetic Example A, or being polled by telephone. If the patient chooses not to be polled electronically, the patient is presented with a card advising the patient that the patient will be contacted by an insurance/polling service and asked to respond to a series of statements and inquiries about the participating physician and the physician's office. On the card, the acceptable responses are listed, as shown in Card 1. There is also an insertion line on the card for the patient to write a number given to them after a successful completion of the survey.

The patient schedules a convenient time for the insurance/polling service to contact the patient to conduct the survey. For those patients unfamiliar with computers, especially elderly patients, and those patients who are not familiar with using typical “voice mail” systems, high survey results will be produced by using the standard telephone survey technique.

As incentive for the patient to participate in the survey, the physician has previously arranged with a local merchant to offer a discount on health and beauty aid products to those participating in the survey. Alternatively, the physician can offer free admission to a health-related seminar or discussion at the physician's office to be held at a later date.

At the pre-arranged, convenient time set by the patient, the telephone survey taker contacts the patient and asks the selected questions regarding the patient's experience with the physician and the physician's office. In order to respond to these selected questions, the patient refers to the card given to the patient at the time of leaving the physician's office containing, for ease of reference, the permissible answers set forth in Card 1 to indicate the patient's satisfaction or dissatisfaction with the services the patient received at the physician's office. The patient enters a response by pressing an appropriate key on the telephone corresponding to the permissible selections on Card 1.

The questions recited to the patient are in pre-recorded form and progress in order every time the patient enters their response by touching the appropriate key on the telephone.

After satisfactorily answering all of the questions, the patient receives an identifying number to be written on the bottom of the paper. Thereafter, the card can then be redeemed, either at the local merchant for discount products or at the physician's office for health-related counseling.

The answers provided by the patient are electronically stored in a previously created database for the particular physician, to be correlated and reviewed at a later date.

This preferable interactive implementation of the Woods Development Institute Customer Survey for Physicians is used to collect the data from a predetermined number of the physician's patients over a preselected period of time. After the required number of patients have been polled, the resulting average patient satisfaction level is compared to predetermined criteria; where the resulting average patient satisfaction level as compared to the predetermined criteria is characterized as “high”, the physician is deemed to be initially qualified for inclusion as a member of the group of physicians having relatively low probability being charged with medical malpractice and hence as qualified to be covered as an insured by the insurance company.

For the accepted physician, satisfaction of that physician's patients over a period of time is thereafter monitored preferably by telephone using the same procedures, equipment and techniques as described above and is documented. This physician member of the group, like all members of the physician group, is thereafter periodically monitored and checked as to probability of being charged with malpractice through the polling of the physician's patients, again preferably using a telephone survey and having the physician's patients answer all the statements appearing in Table 1 while constraining the patient being polled to respond using one of the six responses set forth in Card 1. The polling and monitoring continues as to the satisfaction of patients over forward-going time periods with this polling and monitoring being conducted as described above and patient satisfaction level is compared to the predetermined criteria. So long as the satisfaction level of the physician's patients remains high according to the predetermined criteria, the physician is retained as a member of the group.

### PROPHETIC EXAMPLE D FOR FIG. 2

A candidate seeking inclusion as a member of a group of physicians having relatively low probability of being charged with medical malpractice and hence qualifying for a reduced malpractice insurance premium contacts an insurer, which only insures physicians having a relatively low probability of being charged with malpractice. To qualify for inclusion as a member of the group of physicians having relatively low probability of being charged with medical malpractice and hence qualifying to be insured by the insurance carrier, the physician arranges for placement of an electronic terminal in the physician's offices whereby that physician's patients may be polled as to their satisfaction with a physician's services.

Once the terminal is installed, prior to a patient leaving the physician's office, the patient is requested to sit at the communications terminal and to participate in a patient satisfaction survey. After logging on to the terminal, being provided with a code to preserve the anonymity of the patient and viewing a screen assuring the patient of confidentiality regarding the patient's responses and anonymity regarding the patient's identity, the statements appearing in Table 1 appear individually and sequentially on the computer screen. Coupled with each statement appearing on the computer terminal screen are the permissible responses appearing in Table 2. An exemplary screen for the first statement in Table 1 is set forth as Screen A-1.

The patient touches the computer terminal screen in a spot corresponding to the selected one of the six permissible responses to the first statement appearing in Table 1, as displayed on Screen A-1. Upon the patient touching the screen and indicating which of the six permissible responses the patient has selected, the response is transmitted, preferably via the Internet, to a central computer monitoring station operated by or on behalf of the insurer where that response is stored in a database and identified as being from the patient for the particular physician seeking inclusion as a member of the group. The screen then changes to present the second of the statements in Table 1, appearing as Screen A-2, and elicits the patient's response.

The process is repeated until the particular patient has cycled through all of the separate screens, one for each of the statements appearing in Table 1, and has provided one (1) of the six (6) acceptable responses for each of those statements.

As an alternative, a patient who is requested to participate in the physician satisfaction survey may elect to do so from the patient's home or elsewhere using the patient's home or other remote computer. In that case, the patient communicates via the Internet with the insurance provider or other entity. After providing the patient-participant's name, identification code and seeing a screen assuring the patient of confidentiality and anonymity with respect to use of the survey responses, the patient is presented with a series of screens, such as Screens A-1 and A-2, taking the patient through the statements appearing in Table 1 and constraining the patient to respond to each statements using one of the six permissible responses as set forth in Table 2. The screens presented to the patient appear the same as Screens A-1 and A-2; the patient sequentially indicates the patient's responses by clicking on the selected response thereby transmitting that response for the given screen to a central computer via which data for the physician of interest was being collected. Once the response is transmitted, the screen changes.

This preferable Internet-based, interactive implementation of the Woods Development Institute Customer Survey for Physicians is preferably used to collect the data from a predetermined number of the physician's patients over a preselected period of time. After the required number of patients have been polled and their responses transmitted and processed, the resulting patient satisfaction level is compared to predetermined criteria.

Using suitable tools, most preferably The Woods Development Institute customer survey version for physicians, the predominant patient satisfaction level the physician achieves with his patients is compared to predetermined criteria and is categorized as “low”. As a result, the physician is initially excluded from membership in the group of physicians having relatively low probability of being charged with medical malpractice; the physician is identified as possibly representing a high liability risk.

The candidate member of the physician group is thereafter presented with the option of undergoing standardized cognitive behavioral profiling, preferably via the Internet or other interactive electronic telecommunicative means, to identify and better understand the candidate's cognitive and behavioral profile.

If the physician refuses the option, the physician is dropped as a candidate.

For the cognitive behavioral profiling, the physician preferably sits at the physician's computer terminal and, using a code word supplied to the physician by the insurance company, logs on to the insurance company's central computer via the Internet. Once logged on, a series of screens are presented to the physician with each screen corresponding to one of the attributes appearing in Table 3. Coupled with each attribute as it appears on the computer terminal screen are the permissible responses appearing also in Table 3. Exemplary screens for such interactive cognitive behavioral profiling are set forth as Screens B-1 through B-5.

The physician undergoing the cognitive behavioral profiling touches the computer terminal screen in a spot corresponding to the selected one of the five permissible responses, representing the physician's perception, as displayed on the screen, for example Screen B-1, appearing in front of the physician. Upon the physician touching the screen and indicating which of the five permissible perceptions the physician has selected, the perception response is transmitted, preferably via the Internet, to a central computer monitoring station maintained by the insurance company where that response is stored in a database and identified as being from the particular physician undergoing the cognitive behavioral profiling. The screen then changes to present a next one of the attributes appearing in Table 3 and the physician responds. The process is repeated until the physician has cycled through all of the separate screens, one for each of the attributes appearing in Table 3 and has provided one of the five acceptable perception responses to each one of the presented attributes.

Alternatively, the physician may participate in the cognitive behavioral profiling from the physician's home or elsewhere using the physician's telephone. In such case, after the physician has provided the physician participant's name and identification code, each of the attributes is individually presented, audibly, to the physician via the telephone and the physician responds to the attribute by pressing the corresponding number on the telephone keypad thereby transmitting the response to the insurance company central database. The physician continues this process until having considered all of the attributes listed in Table 3.

If the physician undergoes either standardized or preferably proprietary cognitive behavioral profiling preferably via the Internet or other interactive electronic telecommunication means using the procedure and equipment described above and a low risk profile score results, the physician is admitted to the group.

If the physician has elected to undergo either standardized or preferably proprietary cognitive behavioral profiling, preferably via the Internet or other interactive electronic telecommunication means, and a high-risk profile is confirmed, the physician is initially excluded from membership in the group of physicians having relatively low probability of being charged with malpractice and is asked to undergo either preferably proprietary behavioral modification training or preferably proprietary leadership education, preferably via the Internet or other interactive electronic telecommunication means, with the physician making the selection between the two.

The behavioral modification training or leadership education is provided to the physician via the Internet with a physician logging on the insurance company's proprietary database via the Internet and thereafter interactively receiving training and educational information, providing responses to questions, taking examinations which measure the physician's progress and behavioral modification or development of leadership attributes and the like, until the behavioral modification training or leadership education has been completed. This may take several sessions by the physician.

Upon electing one of the two and completing the elected course, the physician's patient satisfaction is again monitored preferably via the Internet or other interactive electronic telecommunicative means as to satisfaction of that physician's patients over forward-going time periods. Patient satisfaction is polled and monitored using the technique as set forth above with the patients preferably cycling through the screens of which exemplary ones are presented as Screens 1 and 2, to generate additional, new data indicative of the level of patient satisfaction with the physician of interest. The patient satisfaction levels are compared to predetermined criteria.

If the satisfaction level of the physician's patients is then high according to the predetermined criteria, the physician is admitted as a member of the group. This new member of the group, like all members of the group, is thereafter periodically monitored preferably via the Internet or other interactive electronic telecommunication means using the techniques as set forth above as to the satisfaction of patients over forward-going time periods and the patent satisfaction level is periodically compared to predetermined criteria.

However, if the satisfaction level of the physician's patients remains low compared to predetermined criteria over the forward-going time period(s), the physician again is presented with the option to repeat either standardized or preferably proprietary cognitive behavioral profiling preferably via the Internet or other interactive electronic telecommunication means, to again identify and better understand the candidate's cognitive and behavioral profile or to undergo additional preferably proprietary behavior modification training or preferably proprietary leadership education preferably via the Internet or other interactive electronic telecommunication means.

If the physician elects to repeat either standardized or preferably proprietary cognitive behavioral profiling and if the resulting profile is of low risk, the physician is accepted into the group and customer satisfaction monitoring of that physician's patients goes forward, just as it does with the other physician group members. However, if the physician elects to repeat either standardized or preferably proprietary cognitive behavioral profiling preferably via the Internet or other interactive electronic telecommunication means and the resulting profile is one of high risk, then the physician is again presented with the choice of undergoing preferably proprietary behavioral modification training or preferably proprietary leadership education preferably via the Internet or other interactive electronic telecommunication means, and to continue and complete the chosen course and thereafter to continue with patient satisfaction monitoring preferably via the Internet or other interactive electronic telecommunication means.

These behavioral profiling/patient satisfaction monitoring/physician training/education steps of the process are repeated, preferably via the Internet or other interactive electronic telecommunication means, until either the physician qualifies for the low risk group as a result of high patient satisfaction scores or the process is terminated and the physician is rejected for membership in the group.

### PROPHETIC EXAMPLE E FOR FIG. 2

A candidate for inclusion as a member of a group of physicians having relatively low probability of being charged with medical malpractice is preliminarily identified. Satisfaction of that physician's patients over a period of time is monitored and documented preferably via the Internet or other interactive electronic telecommunication means, as described above in Prophetic Example D for FIG. 2. Using suitable tools, most preferably the Wood Development Institute customer survey version for physicians, the predominant patient satisfaction level the physician achieves with his patients is determined, compared to predetermined criteria and is categorized as low. As a result, the physician is initially excluded from membership in the group of physicians having relatively low probability of being charged with medical malpractice; the physician is identified as possibly representing a high liability risk. This candidate member of the physician group is thereafter presented with the option of undergoing standardized or preferably proprietary cognitive behavioral profiling preferably via the Internet or other interactive electronic telecommunication means, as described above in Prophetic Example D for for FIG. 2, to identify and better understand the physician's cognitive and behavioral profile or to participate in either preferably proprietary behavioral modification training or preferably leadership education preferably via the Internet or other interactive electronic telecommunication means.

If the physician elects either standardized or proprietary cognitive behavioral profiling and a low risk profile score results, the physician is admitted to the group.

### PROPHETIC EXAMPLE F FOR FIG. 2

A candidate for inclusion as a member of a group of physicians having relatively low probability of being charged with medical malpractice is preliminarily identified. The satisfaction of that physician's patients over a period of time is monitored and documented preferably via the Internet or other interactive electronic telecommunication means, as described above in Prophetic Example D for FIG. 2. Using suitable tools, most preferably the Woods Development Institute customer version for physicians, the predominant patient satisfaction level the physician achieves with his patients is determined, compared to predetermined criteria and categorized as low. As a result, the physician is initially excluded from membership in the group of physicians having relatively low probability of being charged with medical malpractice; the physician is identified as possibly representing a high liability risk. This candidate member of the physician group is thereafter presented with the option of undergoing either standardized or proprietary cognitive behavioral profiling preferably via the Internet or other interactive electronic telecommunication means, as described above in Prophetic Example D for FIG. 2, to identify and better understand the physician's cognitive and behavioral profile or to participate in either preferably proprietary behavioral modification training or preferably proprietary leadership education preferably via the Internet or other interactive electronic telecommunication means, as described above in Prophetic Example D for FIG. 2.

The physician elects standardized or proprietary cognitive behavioral profiling preferably via the Internet or other interactive electronic telecommunication means, as described above in Prophetic Example D for FIG. 2, and a high-risk profile results. The physician is then asked to undergo either preferably proprietary behavioral modification training or preferably proprietary leadership education preferably via the Internet or other interactive electronic telecommunication means, as described above in Prophetic Example D for FIG. 2, with the physician making the election between the two. Upon electing preferably proprietary behavioral modification training and completing the elected course of instruction and therapy preferably via the Internet or other interactive electronic telecommunication means, as described above in Prophetic Example D for FIG. 2, patient satisfaction is again monitored as to satisfaction of that physician's patients over forward-going time periods. The patient satisfaction levels are compared to predetermined criteria. If the satisfaction level of the physician's patients is then high according to the predetermined criteria, the physician is admitted as a member of the group. This new member of the group, like all members of the group, is thereafter monitored preferably via the Internet or other interactive electronic telecommunication means, as described above in Prophetic Example D for FIG. 2, as to the satisfaction of patients over forward-going time periods and the patent satisfaction level is compared to predetermined criteria.

### PROPHETIC EXAMPLE G FOR FIG. 2

A candidate appearing to be acceptable for admission to medical school and intending after graduation to become a member of a group of physicians having relatively low probability of being charged with medical malpractice is preliminarily identified. The candidate is subjected to standardized or proprietary cognitive behavioral profiling preferably via the Internet or other interactive electronic telecommunication means, as described above in Prophetic Example D for FIG. 2, to identify and better understand the candidate's cognitive behavioral motivational profile. If a high intrinsic motivational profile towards the study of medicine and patient satisfaction is confirmed, the candidate is admitted to the medical school.

### PROPHETIC EXAMPLE H FOR FIG. 2

A candidate appearing to be acceptable for admission to medical school and intending after graduation to become a member of a group of physicians having relatively low probability of being charged with medical malpractice is preliminarily identified. The candidate is subjected to standardized or proprietary cognitive behavioral profiling preferably via the Internet or other interactive electronic telecommunication means, as described above in Prophetic Example D for FIG. 2, to identify and better understand the candidate's cognitive behavioral motivational profile. If a low intrinsic motivational profile towards the study of medicine and patient satisfaction is confirmed, the candidate is conditionally admitted to medical school. This candidate is thereafter required to undergo behavioral modification risk training. Upon successful completion of the same the condition on the candidate's admission to medical school is lifted.

### PROPHETIC EXAMPLE I FOR FIG. 2

A candidate appearing to be acceptable for admission to medical school and intending after graduation to become a member of a group of physicians having relatively low probability of being charged with medical malpractice is preliminarily identified. The candidate is subjected to proprietary or standardized cognitive behavioral profiling preferably via the Internet or other interactive electronic telecommunication means, as described above in Prophetic Example D for FIG. 2, to identify and better understand the candidate's cognitive behavioral motivational profile. If a low intrinsic motivational profile towards the study of medicine and patient satisfaction is confirmed, the candidate is conditionally admitted to medical school. This candidate is thereafter required to undergo leadership education preferably via the Internet or other interactive electronic telecommunication means, as described above in Prophetic Example D for FIG. 2. Upon successful completion of the same the condition on the candidate's admission to medical school is lifted.

### PROPHETIC EXAMPLE J FOR FIG. 2

In the course of assembling and dynamically maintaining a group of professionals having relatively low probability of being charged with professional malpractice, a candidate member of the group is identified. Using a standardized or proprietary customer satisfaction survey, most preferably the Woods Development Institute customer survey version for physicians, customer satisfaction for such candidate member of the group is monitored preferably via the Internet or other interactive electronic telecommunication means, as described above in Prophetic Example D for FIG. 2, over a period of time to evaluate and document the satisfaction the candidate group member is achieving with customers. The customer satisfaction achieved by such candidate member over time is unacceptably low. As a result of the candidate evaluating as having low customer satisfaction over time, the candidate is identified as potentially representing an unacceptably high liability risk and hence as being unqualified, based on present information, for inclusion in the group having relatively low probability of being charged with professional malpractice. The candidate is then required either to submit to proprietary or standardized cognitive behavioral profiling preferably via the Internet or other interactive electronic telecommunication means, as described above in Prophetic Example D for FIG. 2, to identify the candidate's cognitive behavioral profile or to go to either proprietary behavioral modification training or proprietary leadership education and to attend the elected program preferably via the Internet or other interactive electronic telecommunication means, as described above in Prophetic Example D for FIG. 2, until the forward going customer satisfaction data for such candidate reflect a low-risk profile. The candidate elects to undergo proprietary behavioral modification training preferably via the Internet or other interactive electronic telecommunication means, as described above in Prophetic Example D for FIG. 2, for such time until the forward-going customer satisfaction data for such candidate reflects a low-risk profile for customer satisfaction as the candidate continues professional practice. After a sufficient time that forward-going high customer satisfaction data consistently reflects a low risk profile for the candidate, the candidate is admitted into the group.

### PROPHETIC EXAMPLE K FOR FIG. 2

In the course of assembling and dynamically maintaining a group of professionals having relatively low probability of being charged with professional malpractice, a candidate member of the group is identified. Using a proprietary standardized customer satisfaction survey, most preferably the Woods Development Institute customer survey version for physicians, customer satisfaction for such candidate member of the group is monitored preferably via the Internet or other interactive electronic telecommunication means, as described above in Prophetic Example D for FIG. 2, over a period of time to evaluate and document the satisfaction that the candidate group member is achieving with customers. The customer satisfaction achieved by such candidate member over time is unacceptably low. As a result of the candidate evaluating as having low customer satisfaction over time, the candidate is identified as potentially representing an unacceptably high liability risk and hence as being unqualified, based on present information, for inclusion in the group having relatively low probability of being charged with professional malpractice. The candidate is then required either to submit to standardized or proprietary cognitive behavioral profiling preferably via the Internet or other interactive electronic telecommunication means, as described above in Prophetic Example D for FIG. 2, to identify the candidate's cognitive/behavioral profile or to go to either preferably proprietary behavioral modification training or preferably proprietary leadership education preferably via the Internet or other interactive electronic telecommunication means and to attend until the forward going customer satisfaction data for such candidate reflect a low-risk profile. The candidate elects to undergo preferably proprietary behavioral modification training preferably proprietary for such time until the forward-going customer satisfaction data for such candidate reflect a low-risk profile for customer satisfaction as the candidate continues professional practice. After a sufficient time for forward-going customer satisfaction data to reflect a consistent change in customer satisfaction resulting from actions by the candidate, when such data does not consistently reflect a change and hence does not reflect a new low risk profile for the candidate, the candidate is refused admission into the group.

### PROPHETIC EXAMPLE 1 FOR FIG. 3

An employee is evaluated for risk attendant to retaining the employee by first using a standardized or proprietary, most preferably the Woods Development Institute customer survey version for physicians, customer satisfaction survey to monitor customer satisfaction preferably via the Internet or other interactive electronic telecommunication means for such employee over a sufficient period of time to evaluate and document satisfaction or lack thereof with the employee. The documented satisfaction is categorized for such employee as being acceptably high or otherwise unacceptably low. If the employee has high customer satisfaction over the time period, the method proceeds by categorizing such employee as presenting a low liability risk through retention of the employee. Thereafter periodically customer satisfaction is repeatedly monitored, most preferably the Woods Development Institute customer survey version for physicians, for such employee preferably via the Internet or other interactive electronic telecommunication means and the employ is categorized as presenting a low liability risk for so long as the employee evaluates as having such high customer satisfaction; but the method proceeds to identify the employee as possibly representing a high liability risk whenever and if the employee evaluates as having low customer satisfaction. If the employee evaluates as having a low customer satisfaction over time, identifying the employee as potentially representing a high liability risk and requiring the candidate either to submit to standardized or proprietary cognitive/behavioral profiling to identify the employee's client's cognitive behavioral profile; or to go to either preferably proprietary behavioral modification training or preferably proprietary leadership education and to attend the same for such time until the forward-going customer satisfaction data for such employee reflects a low-risk profile. For employees submitting to standardized or proprietary cognitive behavioral profiling, if the employee is determined to have a low-risk cognitive behavioral profile, the method proceeds to categorize or re-categorize the employee as low risk and continues monitoring for customer satisfaction preferably via the Internet or other interactive electronic telecommunication means, most preferably the Woods Development Institute customer survey version for physicians, by such employee. If the employee was determined to have a high-risk cognitive behavioral profile, the employee is required to undergo preferably proprietary behavioral modification training and/or preferably proprietary leadership education and to attend the same for such time until the forward-going customer satisfaction data for such employee reach a desired level reflecting a low-risk profile. An employee given such option who elects to forego the same is discharged. An employee with a previously determined high-risk cognitive behavioral profile who has undergone preferably proprietary behavioral modification training and/or preferably proprietary leadership education for such time until the forward-going customer satisfaction data for such employee reflects a low-risk profile, as such employee continues in professional practice until such time as the forward-going high customer satisfaction data reflects a low risk profile and thereafter categorizing/recategorizing the employee as being of acceptably low risk.

### PROPHETIC EXAMPLE 2 FOR FIG. 3

An insured is evaluated for risk attendant to retaining the insured by first using a standardized customer satisfaction survey to monitor customer satisfaction for such insured over a sufficient period of time to evaluate and document satisfaction or lack thereof with the insured. The documented satisfaction is categorized for such insured as being acceptably high or otherwise unacceptably low. If the insured has high customer satisfaction over the time period, the method proceeds by categorizing such insured as presenting a low liability risk through retention of the insured. Thereafter periodically customer satisfaction is repeatedly monitored for such insured and the insured is categorized as presenting a low liability risk for so long as the insured evaluates as having such high customer satisfaction; but identifying the insured as possibly representing a high liability risk whenever and if the insured evaluates as having low customer satisfaction. If the insured evaluates as having a low customer satisfaction over time, identifying the insured as potentially representing a high liability risk and requiring the insured either to submit to standardized cognitive behavioral profiling to identify the insured's cognitive behavioral profile; or to go to either behavioral modification training or leadership education and to attend the same for such time until the forward-going customer satisfaction data for such insured reflects a low-risk profile. For insureds submitting to standardized cognitive behavioral profiling, if the insured is determined to have a low-risk cognitive behavioral profile, the method proceeds to categorize or re-categorize the insured as low risk and continues monitoring for customer satisfaction by such insured. If the insured was determined to have a high-risk cognitive behavioral profile, the insured is required to undergo behavioral modification training and/or leadership education and to attend the same for such time until the forward-going customer satisfaction data for such insured reach a desired level reflecting a low-risk profile. An insured given such option who elects to forego the same is denied further coverage. An insured with a previously determined high-risk cognitive behavioral profile who has undergone behavioral modification training and/or leadership education for such time until the forward-going customer satisfaction data for such insured reflects a low-risk profile, as such insured, continues in professional practice until such time as the forward-going high customer satisfaction data reflects a low risk profile and thereafter the method proceeds by categorizing/recategorizing the insured as being of acceptably low risk.

### PROPHETIC EXAMPLE 3 FOR FIG. 3

An client is evaluated for risk attendant to retaining the client by first using a standardized or proprietary customer satisfaction survey, most preferably the Woods Development Institute customer survey version for physicians, to monitor customer satisfaction for such client preferably via the Internet or other interactive electronic telecommunication means over a sufficient period of time to evaluate and document satisfaction or lack thereof with the client under consideration. The documented satisfaction is categorized for such client as being acceptably high or otherwise unacceptably low. If the client has high customer satisfaction over the time period, categorizing such client as presenting a low liability risk through retention of the client. Thereafter periodically customer satisfaction, most preferably the Woods Development Institute customer survey version for physicians, is repeatedly monitored for such client and the employee is categorized as presenting a low liability risk for so long as the client evaluates as having such high customer satisfaction; the client is identified as possibly representing a high liability risk whenever and if the client evaluates as having low customer satisfaction. If the client evaluates as having a low customer satisfaction over time, the client is identified as potentially representing a high liability risk and the candidate is required either to submit to standardized or proprietary cognitive/behavioral profiling to identify the client's cognitive/behavioral profile; or to go to either preferably proprietary behavioral modification training or preferably proprietary leadership education and to attend the same for such time until the forward-going customer satisfaction data for such client reflects a low-risk profile. For clients submitting to standardized or proprietary cognitive behavioral profiling, if the client is determined to have a low-risk cognitive behavioral profile, categorizing or re-categorizing the client as low risk preferably via the Internet or other interactive electronic telecommunication means and continue monitoring preferably via the Internet or other interactive electronic telecommunication means or customer satisfaction by such client. If the client was determined to have a high-risk cognitive behavioral profile, the client is required to undergo preferably proprietary behavioral modification training and/or preferably proprietary leadership education preferably via the Internet or other interactive electronic telecommunication means and to attend the same for such time until the forward-going customer satisfaction data for such client reach a desired level reflecting a low-risk profile. A high risk client given such option who elects to forego the same is discharged. A client with a previously determined high-risk cognitive behavioral profile who has undergone preferably proprietary behavioral modification preferably proprietary training and/or leadership education preferably via the Internet or other interactive electronic telecommunication means or such time continues in professional practice until such time as the forward-going high customer satisfaction data reflects a low risk profile whereupon the client is categorized or re-categorized as being of acceptably low risk.

### PROPHETIC EXAMPLE A FOR FIG. 3

An employee is evaluated for the employer's risk attendant to retaining that employee by first using a standardized or proprietary, most preferably the Woods Development Institute customer satisfaction survey to monitor customer satisfaction preferably via the Internet or other interactive electronic telecommunication means, as described above in Prophetic Example D for FIG. 2, for such employee over a sufficient period of time to evaluate and document satisfaction or lack thereof with the employee. The documented satisfaction is categorized for such employee as being acceptably high or otherwise unacceptably low. If the employee has high customer satisfaction over the time period, the method proceeds by categorizing such employee as presenting a low liability risk to the employer through retention of the employee. Thereafter, customer satisfaction is periodically repeatedly monitored, most preferably using the Woods Development Institute customer survey version for physicians, for such employee preferably via the Internet or other interactive electronic telecommunication means, as described above in Prophetic Example D for FIG. 2. The employee is categorized as presenting a low liability risk for so long as the employee evaluates as having such high customer satisfaction; but the method proceeds to identify the employee as possibly representing a high liability risk to the employer whenever and if the employee evaluates as having low customer satisfaction. If the employee evaluates as having a low customer satisfaction over time, the method identifies the employee as potentially representing a high liability risk and requires the employee either to submit to standardized or proprietary cognitive/behavioral profiling to identify the employee's cognitive behavioral profile, as described above in Prophetic Example D for FIG. 2; or to go either to preferably proprietary behavioral modification training or to preferably proprietary leadership education and to attend the same for such time until the forward-going customer satisfaction data, as described above in Prophetic Example D for FIG. 2, for such employee reflects a low-risk profile.

For employees submitting to standardized or proprietary cognitive behavioral profiling, if the employee is determined to have a low-risk cognitive behavioral profile, the method proceeds to categorize or re-categorize the employee as low risk and continues monitoring for customer satisfaction preferably via the Internet or other interactive electronic telecommunication means, as described above in Prophetic Example D for FIG. 2, most preferably the Woods Development Institute customer survey version for physicians, by such employee. If the employee was determined to have a high-risk cognitive behavioral profile, the employee is required to undergo preferably Internet-based proprietary behavioral modification training and/or preferably proprietary leadership education and to attend the same for such time until the forward-going customer satisfaction data for such employee reach a desired level reflecting a low-risk profile.

An employee given such option who elects to forego the same is discharged.

An employee with a previously determined high-risk cognitive behavioral profile who has undergone preferably proprietary behavioral modification training and/or preferably proprietary leadership education for such time until the forward-going customer satisfaction data, as described above in Prophetic Example D for FIG. 2, for such employee reflects a low-risk profile, results in such employee being categorized or recategorized as being of acceptably low risk.

### PROPHETIC EXAMPLE B FOR FIG. 3

An insured is evaluated for risk attendant to retaining the insured by first using a standardized customer satisfaction survey, as described above in Prophetic Example D for FIG. 2, to monitor customer satisfaction for such insured over a sufficient period of time to evaluate and document satisfaction or lack thereof with the insured. The documented satisfaction is categorized for such insured as being acceptably high or otherwise unacceptably low. If the insured has high customer satisfaction over the time period, the method proceeds by categorizing such insured as presenting a low liability risk through retention of the insured. Thereafter periodically customer satisfaction is repeatedly monitored for such insured, as described above in Prophetic Example D for FIG. 2, and the insured is categorized as presenting a low liability risk for so long as the insured evaluates as having such high customer satisfaction; the insured is identified as possibly representing a high liability risk whenever and if the insured evaluates as having low customer satisfaction.

If the insured evaluates as having a low customer satisfaction over time, the method proceeds by identifying the insured as potentially representing a high liability risk and requiring the insured either to submit to standardized cognitive behavioral profiling to identify the insured's cognitive behavioral profile or to either participate in preferably Internet-based behavioral modification training or leadership education and to participate in the same for such time until the forward-going customer satisfaction data, as described above in Prophetic Example D for FIG. 2, for such insured reflects a low-risk profile.

For insureds submitting to standardized cognitive behavioral profiling, if the insured is determined to have a low-risk cognitive behavioral profile, the method proceeds to categorize or re-categorize the insured as low risk and continues monitoring for customer satisfaction, as described above in Prophetic Example D for FIG. 2, by such insured. If the insured is determined to have a high-risk cognitive behavioral profile, the insured is required to undergo, preferably Internet-based behavioral modification training and/or leadership education and to continue the same for such time until the forward-going customer satisfaction data, as described above in Prophetic Example D for FIG. 2, for such insured reach a desired level reflecting a low-risk profile.

An insured given such option and electing to forego the same is denied further coverage.

An insured with a previously determined high-risk cognitive behavioral profile who has undergone behavioral modification training and/or leadership education for such time until the forward-going customer satisfaction data for such insured reflects a low-risk profile continues in professional practice and is thereafter categorized/recategorized as being of acceptably low risk.

### PROPHETIC EXAMPLE C FOR FIG. 3

A client is evaluated for risk attendant to retaining the client by first using a standardized or proprietary customer satisfaction survey, most preferably the Woods Development Institute customer survey version for physicians, to monitor satisfaction of such client preferably via the Internet or other interactive electronic telecommunication means, as described above in Prophetic Example D for FIG. 2, over a sufficient period of time to evaluate and document satisfaction or lack thereof in the client under consideration. The documented satisfaction is categorized for such client as being acceptably high or otherwise unacceptably low. If the client has high satisfaction over the time period, the method proceeds by categorizing such client as presenting a low liability risk through retention of the client. Thereafter periodically client satisfaction, most preferably the Woods Development Institute customer survey, is repeatedly performed by such client and the client is categorized as presenting a low liability risk for so long as the client evaluates as having such high satisfaction. However, the client is identified as possibly representing a high liability risk whenever and if the client evaluates as having low satisfaction.

If the client evaluates as having a low satisfaction over time, the client is identified as potentially representing a high liability risk and the candidate is required either to submit to standardized or proprietary cognitive/behavioral profiling, as described above in Prophetic Example D for FIG. 2, to identify the client's cognitive/behavioral profile; or to go to either preferably proprietary behavioral modification training or preferably proprietary leadership education and to attend the same for such time until the forward-going customer satisfaction data for such client reflects a low-risk profile. For clients submitting to standardized or proprietary cognitive behavioral profiling, if the client is determined to have a low-risk cognitive behavioral profile, categorizing or re-categorizing the client as low risk preferably via the Internet or other interactive electronic telecommunication means and continue monitoring preferably via the Internet or other interactive electronic telecommunication means or customer satisfaction by such client. If the client was determined to have a high-risk cognitive behavioral profile, the client is required to undergo preferably proprietary behavioral modification training and/or preferably proprietary leadership education preferably via the Internet or other interactive electronic telecommunication means and to attend the same for such time until the forward-going customer satisfaction data for such client reach a desired level reflecting a low-risk profile.

A high risk client given such option who elects to forego the same is discharged.

A client with a previously determined high-risk cognitive behavioral profile who has undergone preferably proprietary behavioral modification preferably proprietary training and/or leadership education preferably via the Internet or other interactive electronic telecommunication means or such time continues in professional practice until such time as the forward-going high customer satisfaction data reflects a low risk profile whereupon the client is categorized or re-categorized as being of acceptably low risk.

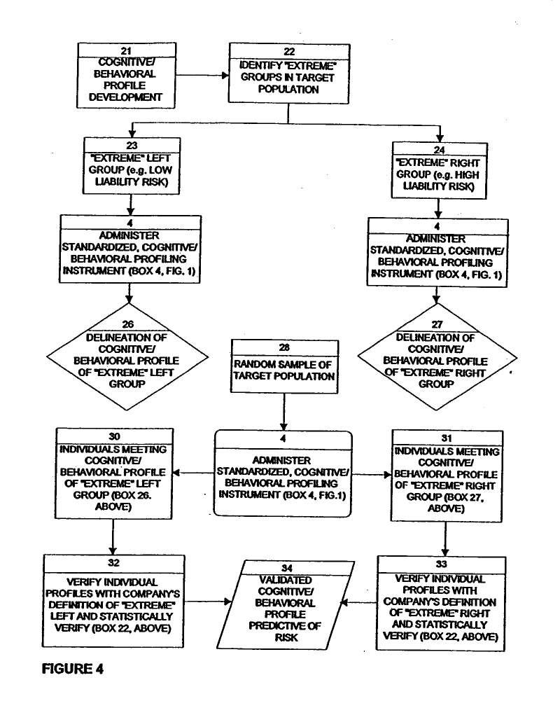

### PROPHETIC EXAMPLE 1 FOR FIG. 4

An institution develops a cognitive behavioral profile predictive of risk according to institutionally predefined parameters proceeds by first defining a target population of interest to the institution. Development of the profile proceeds by identifying, within the target population of interest, mutually exclusive groups of high risk and low risk individuals according to said institutionally predefined parameters. The institution then causes the individuals in said high and low risk groups from said target population to undergo standardized or proprietary cognitive behavioral profiling evaluation in order to delineate and document cognitive behavioral group profiles of the institutionally defined high risk and low risk groups from the target population of interest. The procedure then randomly selects, from the target population of interest, a group of sufficient number that selection of some individuals from both of the institutionally defined high and the low risk groups is statistically assured. The individuals in the randomly selected group are required to undergo standardized or proprietary cognitive behavioral profiling evaluation. The procedure continues by dividing the evaluated individuals in the randomly selected group, according to their profiles resulting from the standardized cognitive or proprietary behavioral profiling evaluation, into second high and low risk groups respectively meeting the standardized or proprietary cognitive behavioral profiles of the institutionally defined mutually exclusive groups of high risk and low risk individuals. The procedure continues by individually checking the members of the second high and low risk groups to determine if they were in one of the mutually exclusive groups of institutionally defined high risk and low risk individuals as previously defined, and for those individuals who were in either one of those groups, checking that the standardized or proprietary cognitive behavioral profile for that individual meets/matches the standardized or proprietary cognitive behavioral profiles for the appropriate one of the institutionally defined high and low risk groups. The method then statistically verifies and correlates the standardized or proprietary cognitive behavioral profiles for the members of the second high and low risk groups with the standardized or proprietary cognitive behavioral profiles for the appropriate one of the institutionally defined high and low risk groups. This is done to determine the likelihood or probability that a given individual with a given standardized or proprietary cognitive behavioral profile is or is not within either of the institutionally defined high or low risk categories in order to define a confidence level associated with assigning a given individual to one of the institutionally defined high or low risk categories based on that individual's standardized or proprietary cognitive behavioral profile.

### PROPHETIC EXAMPLE A FOR FIG. 4

An institution develops a cognitive behavioral profile predictive of risk according to institutionally predefined parameters proceeds by first defining a target population of interest to the institution. Development of the profile proceeds by identifying, within the target population of interest, mutually exclusive groups of high risk and low risk individuals according to said institutionally predefined parameters. The institution then causes the individuals in said high and low risk groups from said target population to undergo standardized cognitive behavioral profiling evaluation, as described above in Prophetic Example D for FIG. 2, in order to delineate and document cognitive behavioral group profiles of the institutionally defined high risk and low risk groups from the target population of interest. The procedure then randomly selects, from the target population of interest, a group of sufficient number that selection of some individuals from both of the institutionally defined high and the low risk groups is statistically assured.

The individuals in the randomly selected group are required to undergo standardized cognitive behavioral profiling evaluation, as described above in Prophetic Example D for FIG. 2. The procedure continues by dividing the evaluated individuals in the randomly selected group, according to their profiles resulting from the standardized cognitive behavioral profiling evaluation, into second high and low risk groups respectively meeting the standardized cognitive behavioral profiles of the institutionally defined mutually exclusive groups of high risk and low risk individuals. The procedure continues by individually electronically checking in the master computer database the members of the second high and low risk groups to determine if they were in one of the mutually exclusive groups of institutionally defined high risk and low risk individuals as previously defined, and for those individuals who were in either one of those groups, electronically checking, in the master computer database, that the standardized cognitive behavioral profile for that individual meets/matches the standardized cognitive behavioral profiles for the appropriate one of the institutionally defined high and low risk groups. The method then uses the central computer to electronically statistically verify and correlate the standardized cognitive behavioral profiles for the members of the second high and low risk groups with the standardized cognitive behavioral profiles for the appropriate one of the institutionally defined high and low risk groups. This is done to determine the likelihood or probability that a given individual with a given standardized cognitive behavioral profile is or is not within either of the institutionally defined high or low risk categories in order to define a confidence level associated with assigning a given individual to one of the institutionally defined high or low risk categories based on that individual's standardized cognitive behavioral profile.

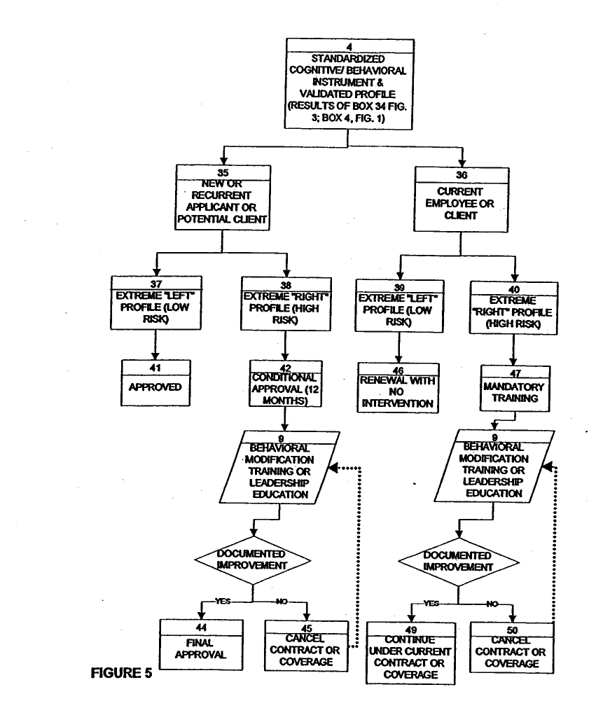

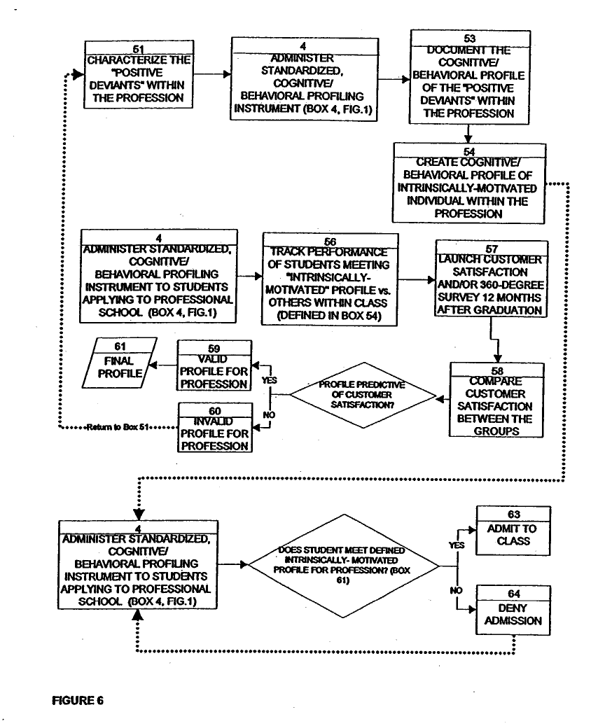

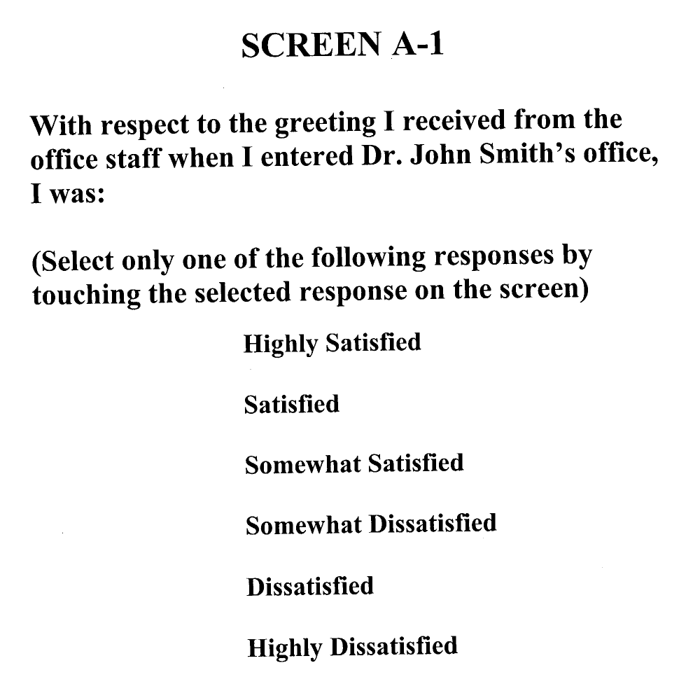

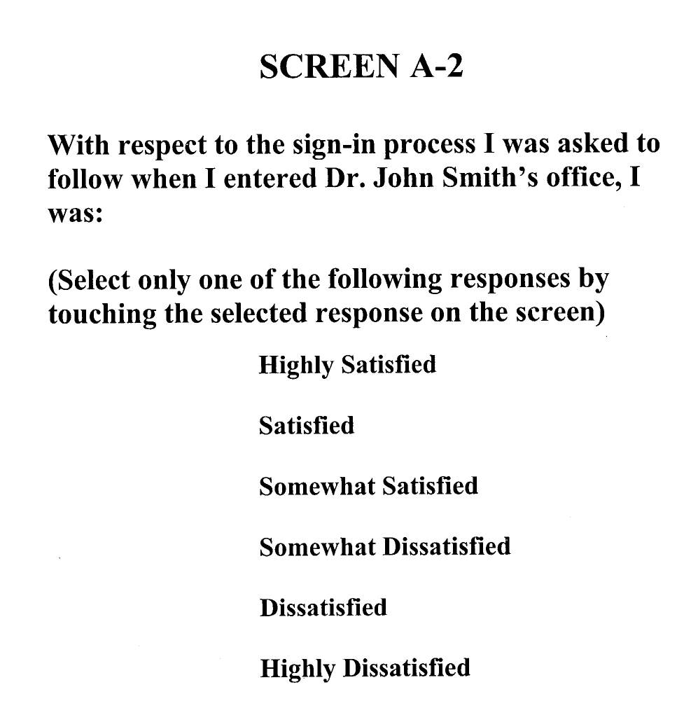

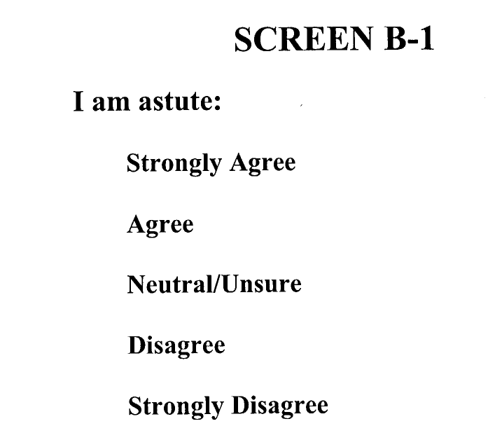

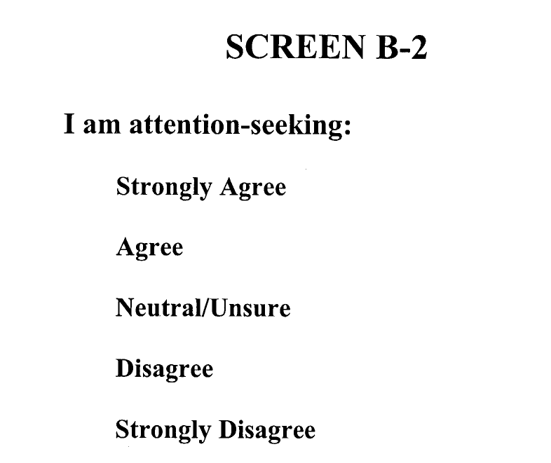

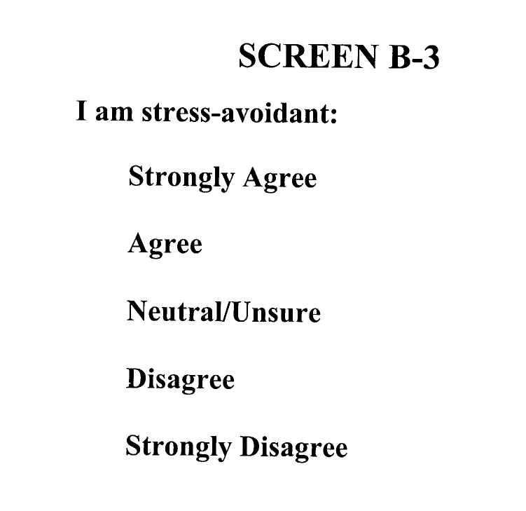

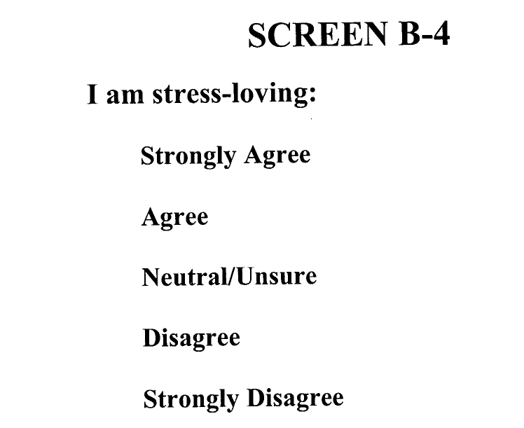

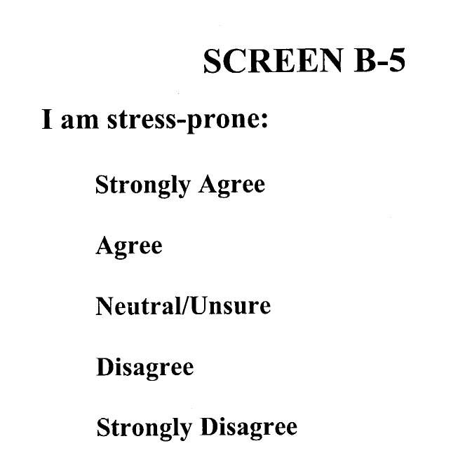

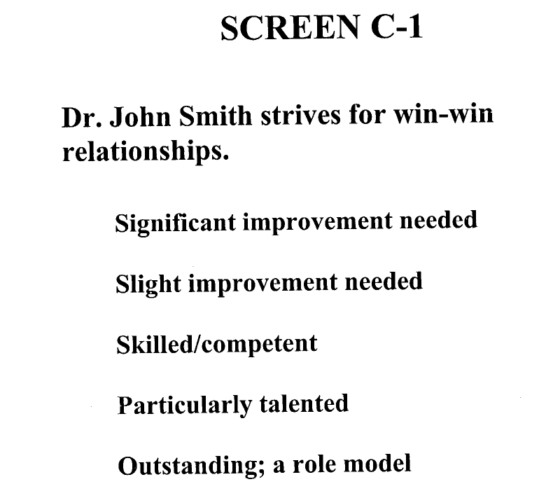

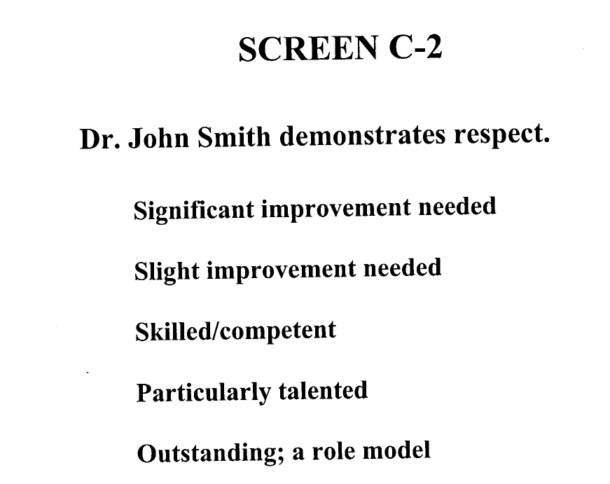

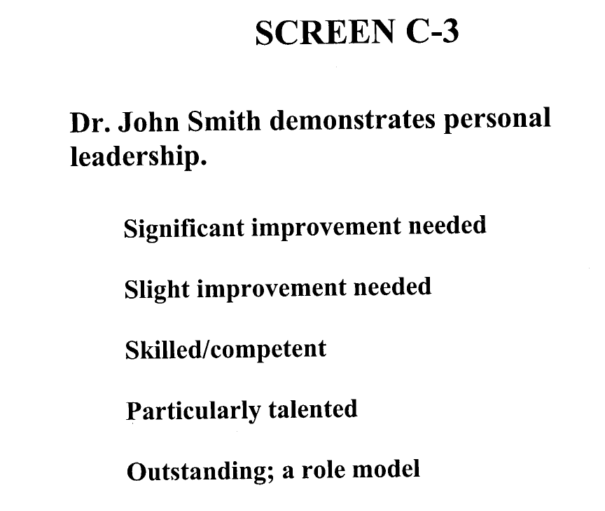

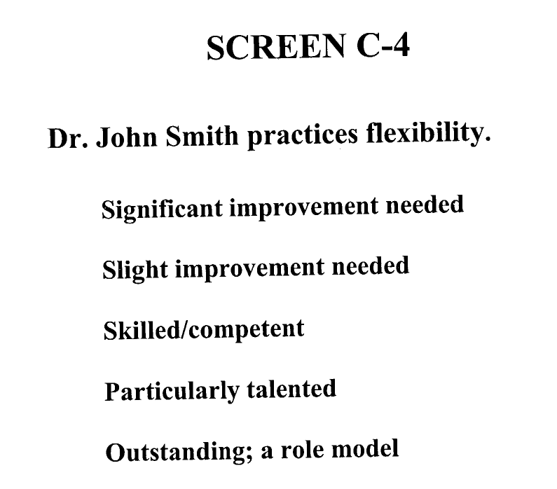

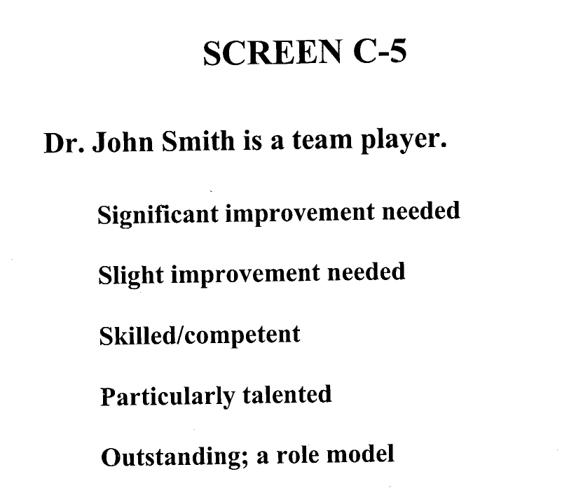

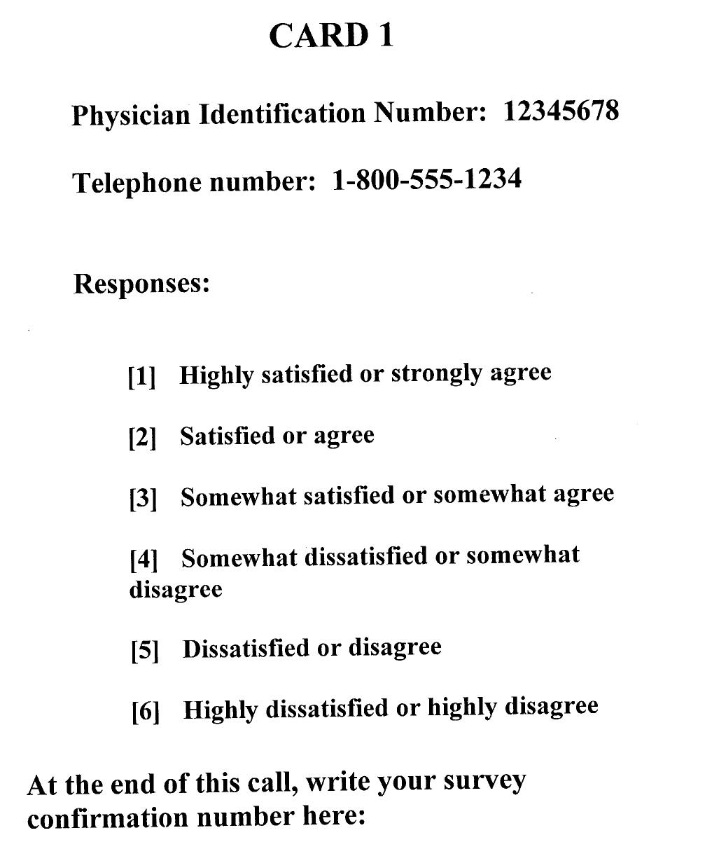

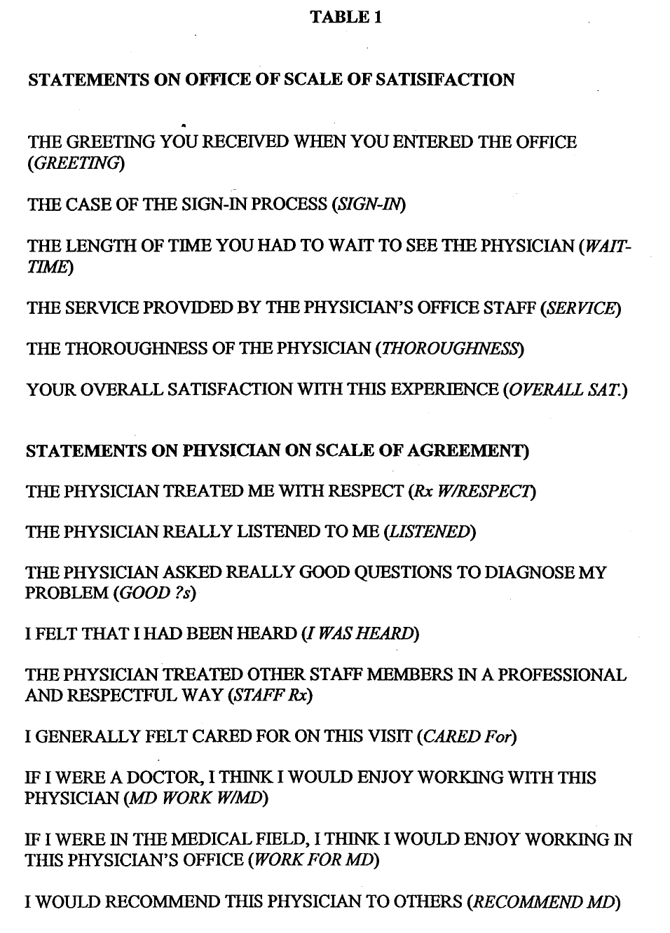

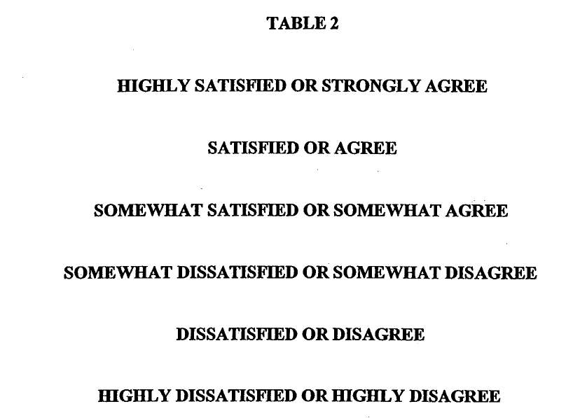

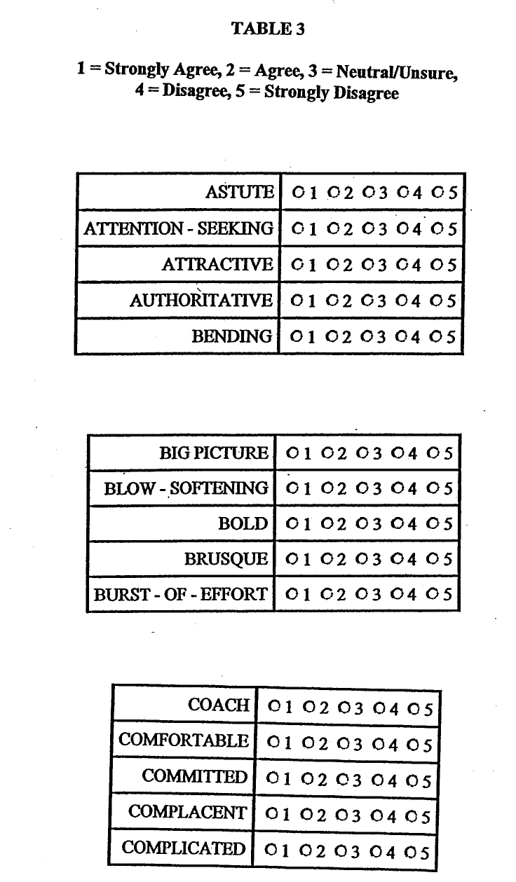

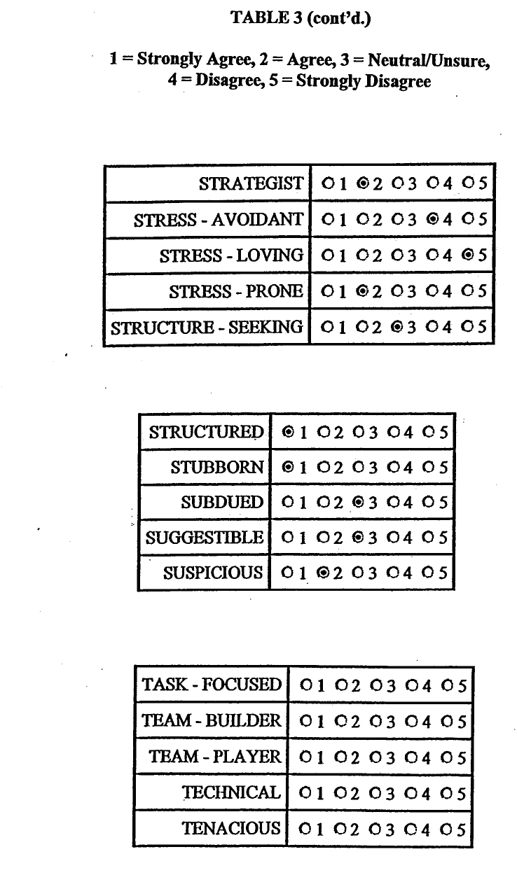

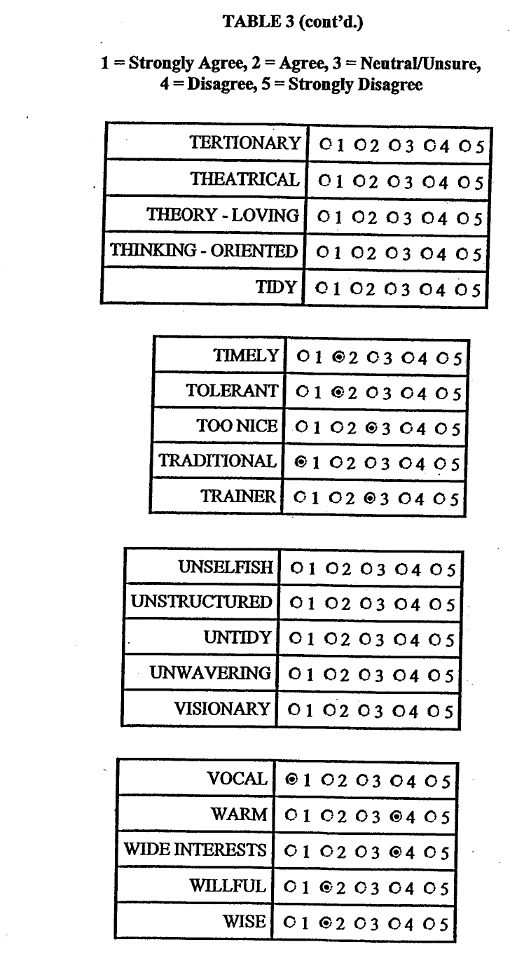

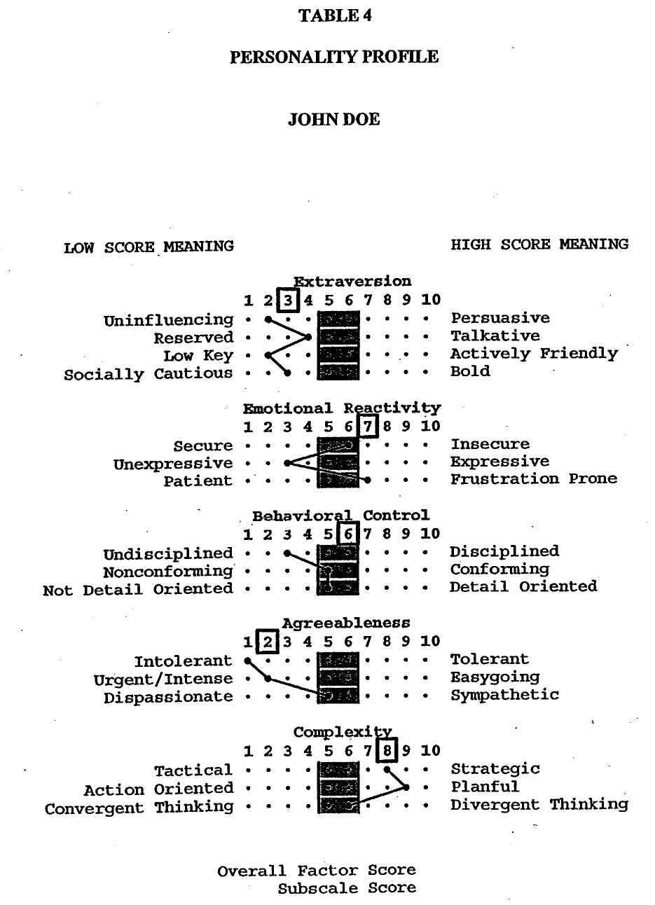

### PROPHETIC EXAMPLE 1 FOR FIG. 5

An institution identifying acceptable and unacceptable risk in a target formulation of new or renewal applicants for employment or insurance and/or other services and instituting corrective/remedial training for those new or renewal applicants for employment or insurance or other services which are identified as manifesting unacceptable risk in such target population begins with obtaining a standardized or proprietary cognitive behavioral profile for the individual new or renewal applicant. The procedure for identifying acceptable/unacceptable risk proceeds with the step of comparing the individual's standardized or proprietary cognitive behavioral profile to previously obtained ranges of profiles for persons manifesting acceptably low and unacceptably high risks with respect to the employment activity, insurance or other services of interest. Next, the individual is identified as being an acceptable risk if the individual's standardized or preferably proprietary cognitive behavioral profile is within the range for persons of acceptably low risk, but as being an unacceptable risk if the individual's standardized or proprietary cognitive behavioral profile is within the range for persons of high risk. The remedial aspect of the procedure proceeds for an individual identified as being of acceptably low risk, by approving continued insurance and/or other benefit coverage for that individual and monitoring forward going customer satisfaction for that individual using a selected standardized or proprietary, most preferably the Woods Development Institute customer survey version for physicians customer satisfaction survey. The remedial aspect of the procedure further proceeds for an individual identified as being of unacceptably high risk by conditionally approving continuation of such insurance and other benefit coverage for that individual on the condition of the individual entering and completing a preferably proprietary behavioral modification training or preferably proprietary leadership education program with demonstrated improvement over the one year duration of the program or the approved insurance and benefit coverage will be cancelled and once the individual employee has completed the preferably proprietary behavioral modification training or the preferably proprietary leadership education program and demonstrated the required improvement over the one year duration, by removing the condition on the approval of the insurance and benefit coverage and monitoring forward going customer satisfaction for that individual using the selected customer satisfaction survey, most preferably the Woods Development Institute customer survey version for physicians.

### PROPHETIC EXAMPLE 2 FOR FIG. 5

An institution seeking to identify acceptable and unacceptable risk in individuals in a target population, for granting insurance and/or other benefits and instituting corrective/remedial training for those identified as manifesting unacceptable risk in such target population, begins with obtaining a standardized or proprietary, most preferably the Woods Development Institute customer survey version for physicians, cognitive behavioral profile for an individual of interest from the target population. The procedure for identifying acceptable/unacceptable risk proceeds with the step of comparing the individual's standardized or proprietary cognitive behavioral profile to previously obtained ranges of profiles for persons of acceptably low and unacceptably high risks. Next, the individual is identified as being an acceptable risk if the individual's elicited cognitive behavioral profile is within the range for persons of acceptably low risk, but as being an unacceptable risk if the individual's standardized cognitive behavioral profile is within the range for persons of high risk.

The remedial aspect of the procedure proceeds for an individual identified as being of acceptably low risk, by approving continued insurance and/or other benefit coverage for that individual and monitoring forward-going customer satisfaction for that individual using a selected customer satisfaction survey, most preferably the Woods Development Institute customer survey version for physicians.

The remedial aspect of the procedure further proceeds for an individual identified as being of unacceptably high risk by conditionally approving continuation of such insurance and other benefit coverage for that individual on the condition of the individual entering and completing a preferably proprietary behavioral modification training or preferably proprietary leadership education program with demonstrated improvement over the one year duration of the program or the approved insurance and benefit coverage cancelled. Once the individual employee has completed the preferably proprietary behavioral modification training or the leadership education program and demonstrated the required improvement over the one year duration, the condition on the approval of the insurance and benefit coverage is removed and forward-going customer satisfaction for that individual is monitored using the selected customer satisfaction survey, most preferably the Woods Development Institute customer survey version for physicians.

### PROPHETIC EXAMPLE A FOR FIG. 5

An institution identifying acceptable and unacceptable risk in a target formulation of new or renewal applicants for employment or insurance and/or other services and instituting corrective/remedial training for those new or renewal applicants for employment or insurance or other services which are identified as manifesting unacceptable risk in such target population begins with obtaining a standardized or proprietary cognitive behavioral profile for the individual new or renewal applicant, as described above in Prophetic Example D for FIG. 2. The procedure for identifying acceptable/unacceptable risk proceeds with the step of comparing the individual's standardized or proprietary cognitive behavioral profile to previously obtained ranges of profiles for persons manifesting acceptably low and unacceptably high risks with respect to the employment activity, insurance or other services of interest. Next, the individual is identified as being an acceptable risk if the individual's standardized or preferably proprietary cognitive behavioral profile is within the range for persons of acceptably low risk, but as being an unacceptable risk if the individual's standardized or proprietary cognitive behavioral profile is within the range for persons of high risk.

The remedial aspect of the procedure proceeds for an individual identified as being of acceptably low risk, by approving continued insurance and/or other benefit coverage for that individual and monitoring forward going customer satisfaction for that individual by customer polling using a selected standardized or proprietary, most preferably the Woods Development Institute customer satisfaction survey, as described above in Prophetic Example D for FIG. 2. The remedial aspect of the procedure further proceeds for an individual identified as being of unacceptably high risk by conditionally approving continuation of such insurance and other benefit coverage for that individual on the condition of the individual entering and completing a preferably proprietary behavioral modification training or preferably Internet-based, preferably proprietary leadership education program with demonstrated improvement over the one year duration of the program, as described above in Prophetic Example D for FIG. 2, or the approved insurance and benefit coverage will be cancelled. Once the individual employee has completed the preferably proprietary behavioral modification training or the preferably proprietary leadership education program and demonstrated the required improvement over the one year duration, by removing the condition on the approval of the insurance and benefit coverage and monitoring forward going customer satisfaction for that individual using the selected customer satisfaction survey, as described above in Prophetic Example D for FIG. 2, most preferably the Woods Development Institute customer satisfaction survey.

For an employee, physician or other professional who has completed behavioral modification training and/or leadership training successfully and has been admitted to the group, that candidate is preferably periodically telecommunicatively examined as to whether the candidate has maintained the previously effectuated acceptable behavior modification and/or has maintained the sufficient and acceptable leadership skills, relative to predetermined criteria for persons who have been successful in the profession and relative to others in the group such as to be maintained as included in the group.

For a member of the group having successfully completed the behavioral modification training and/or leadership training and having been admitted to the group on such basis, preferably at least some monitoring for continued acceptable behavioral characteristics and leadership traits for the group member is performed preferably by sequentially electronically presenting, separately to the group member and individually separately to the group members' professional associates, office staff members, supervisors and others having regular contact with the group member and hence having the opportunity to observe the group member in a variety professional situations, a series of statements on a video screen. These statements seek to elicit the perceptions of the persons sitting at the screen regarding a group member's behavioral characteristics in leadership traits. Each statement is accompanied by a permissible set of responses to the statement.

A typical set of screens that would be sequentially displayed to a person being surveyed, as respects a physician group member behavioral modification or leadership trait, appear as Screens C1 through C-5. The person sitting at the video terminal is electronically induced to select one of the permissible responses for each of the statements sequentially appearing on the screen. The person is prompted with a graphical and/or audible signal transmitted from a remote location. This signal directs the person sitting at the screen to select one of the permissible responses either by tactile contact with the video screen and/or by manual manipulation of an input device, such as a mouse, to select one of the five permissible responses. Each response is electronically transmitted to be received and collected at a remote locale. The responses are collected as the persons sitting at the screen goes through the entire set of screens, providing that person's perceptions as to the group members' behavior, behavioral modification and leadership skill maintenance.

This series of steps is repeated for a selected number of persons for the group member of interest so that an adequate statistical basis for evaluating the group member's continued behavioral modification and/or continued maintenance of leadership skills exists. These responses are electronically assembled and collected as central database at a remote locale relative to the computer terminal. The responses are then electronically processed for each of the responding persons for the group member to determine to the perceived behavioral characteristics and leadership traits of the group member as determined by the persons interrogated. The perceived behavioral characteristic profile and the perceived leadership trait profile for the group members are electronically compared to preselected criteria whereupon the perceived behavioral characteristic profile and the perceived leadership trait profile for the group member of interest over time is categorized as being satisfactory or unsatisfactory based on the collective responses from the participating persons over time. As a result, the member of the group of interest is maintained as a member of the group or is removed from the group, according to the perceived behavioral characteristic profile and the perceived leadership trait profile as elicited from persons in position to observe the behavior and leadership of the group member of interest.

### PROPHETIC EXAMPLE B FOR FIG. 5

An institution seeking to identify acceptable and unacceptable risk in individuals in a target population, for granting insurance and/or other benefits and instituting corrective/remedial training for those identified as manifesting unacceptable risk in such target population, begins with obtaining a standardized or proprietary, most preferably the Woods Development Institute customer survey version for physicians, cognitive behavioral profile, as described above in Prophetic Example D for FIG. 2, for an individual of interest from the target population. The procedure for identifying acceptable/unacceptable risk proceeds with the step of comparing the individual's standardized or proprietary cognitive behavioral profile, as described above in Prophetic Example D for FIG. 2, to previously obtained ranges of profiles for persons of acceptably low and unacceptably high risks. Next, the individual is identified as being an acceptable risk if the individual's elicited cognitive behavioral profile, as described above in Prophetic Example D for FIG. 2, is within the range for persons of acceptably low risk, but as being an unacceptable risk if the individual's standardized cognitive behavioral profile, as described above in Prophetic Example D for FIG. 2, is within the range for persons of high risk.

The remedial aspect of the procedure proceeds for an individual identified as being of acceptably low risk, by approving continued insurance and/or other benefit coverage for that individual and monitoring forward-going customer satisfaction, as described above in Prophetic Example D for FIG. 2, for that individual using a selected customer satisfaction survey, most preferably the Woods Development Institute customer survey.

The remedial aspect of the procedure further proceeds for an individual identified as being of unacceptably high risk by conditionally approving continuation of such insurance and other benefit coverage for that individual on the condition of the individual entering and completing a preferably Internet-based proprietary behavioral modification training or preferably proprietary leadership education program with demonstrated improvement over the one year duration of the program or the approved insurance and benefit coverage cancelled. Once the individual employee has completed the preferably proprietary behavioral modification training or the leadership education program and demonstrated the required improvement over the one year duration, the condition on the approval of the insurance and benefit coverage is removed and forward-going customer satisfaction for that individual is monitored using the selected customer satisfaction survey, most preferably the Woods Development Institute customer survey.

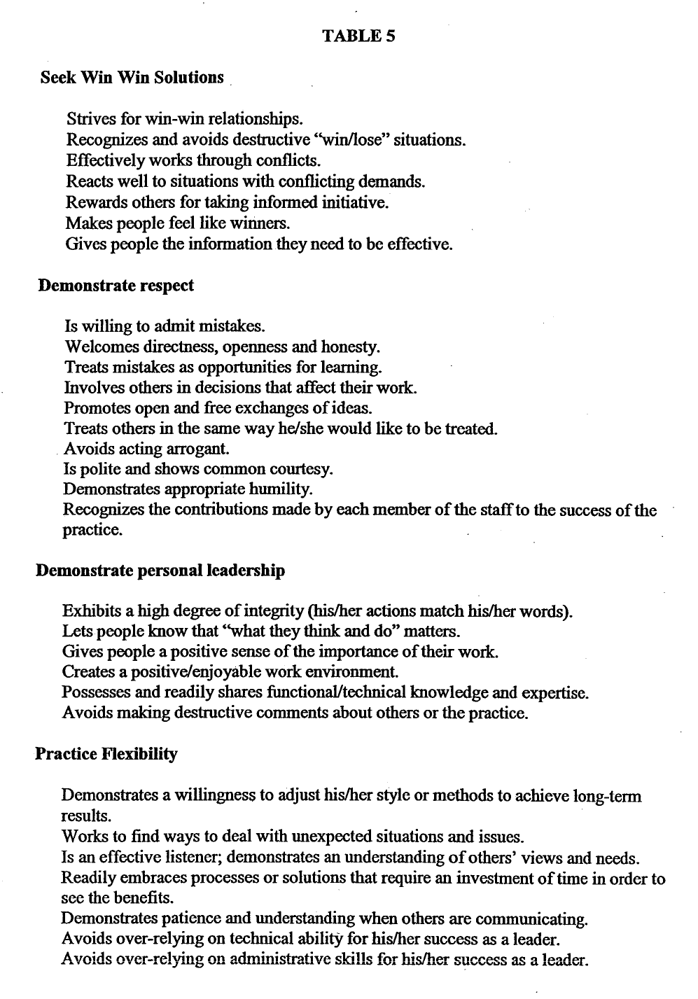

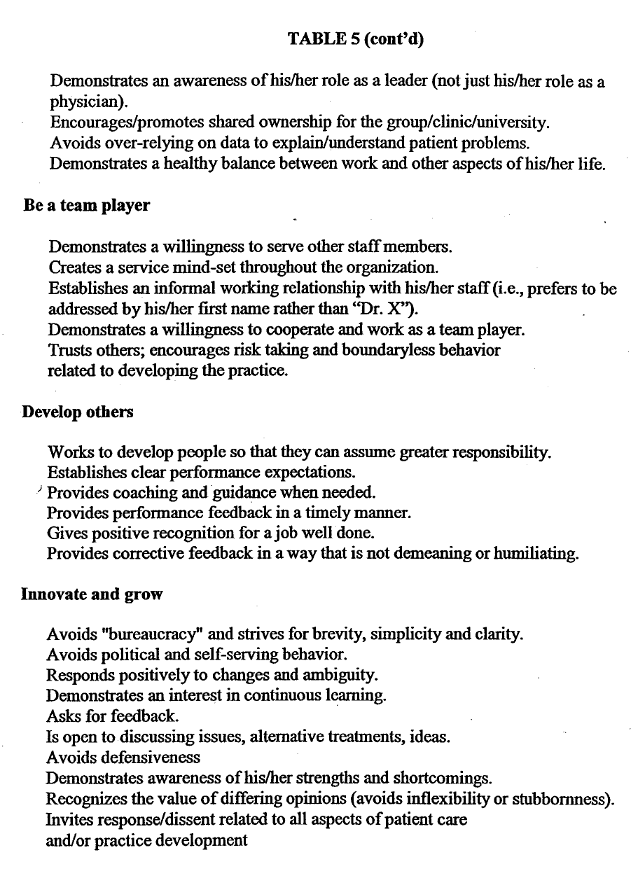

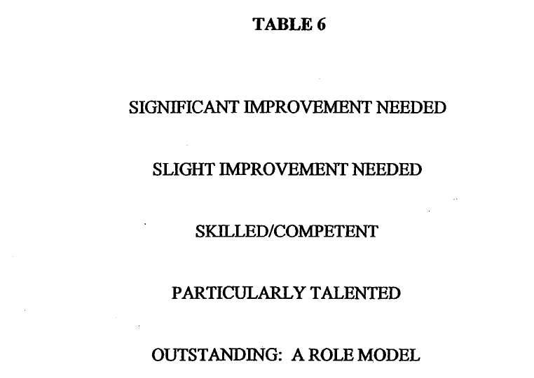

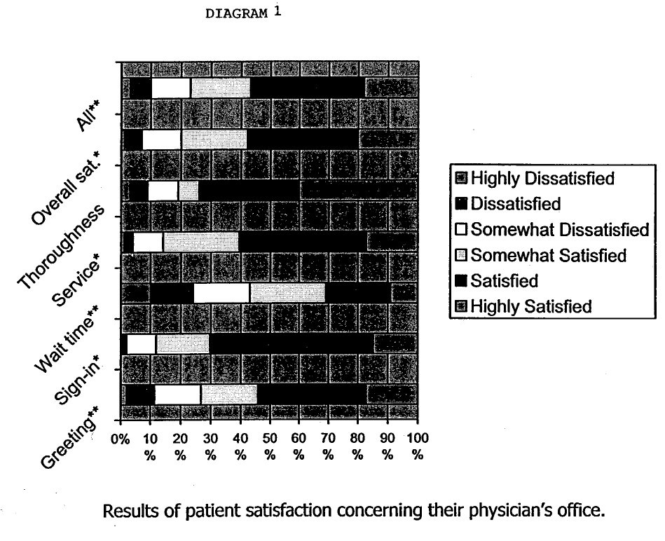

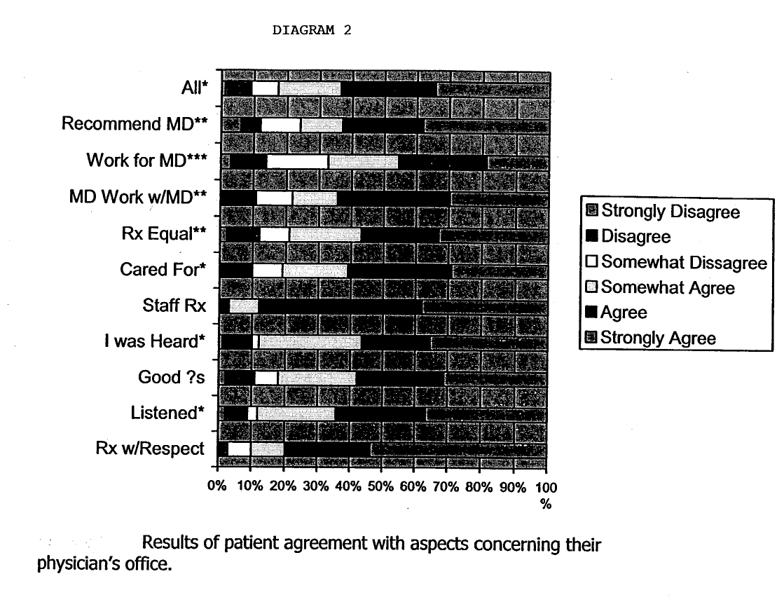

### PROPHETIC EXAMPLE 1 FOR FIG. 6

A professional school or professional accrediting agency implements a method for evaluating candidates for admission to the professional school and providing a group of intrinsically motivated candidates which after acceptance and upon graduation the school from such school will, as a group of such professionals, have substantially statistically lower probability of being charged with professional malpractice. The implementation of the method also provides guidance for selected members of the group of accepted candidates as needed to further lower their probability of being so-charged with professional malpractice subsequent to graduation.

The method commences with the school identifying a sufficient number of practicing individuals in the profession of interest which fit the accepted definition of positive deviants in the profession. A positive deviant is one in the profession whose exceptional behavior and/or practices enable them to achieve superior results relative to others in the profession working with the same resources. The school needs to develop a standardized or proprietary cognitive behavioral profile for positive deviants in the profession of interest in order to implement the method and so proceeds to subject the identified positive deviant individuals practicing the profession to standardized or proprietary cognitive behavioral profiling. Using the results of the standardized or proprietary cognitive behavioral profiling, the school documents and establishes a standardized or proprietary cognitive behavioral profile for positive deviants in the profession of interest. The school then proceeds to create a standardized or proprietary cognitive behavioral profile of those who are intrinsically motivated positive deviant persons within the profession by analysis of the results for identified intrinsically motivated individuals within the sampled positive deviant population of those in the profession of interest and the results of the standardized or proprietary cognitive behavioral profiling of the positive deviants. The school then proceeds by administering a standardized or proprietary cognitive behavioral profiling instrument to student candidates for the professional school. The school then compares each student's resulting profile to the previously determined standardized or proprietary cognitive behavioral profile for intrinsically motivated persons within the profession and admits those student candidates to the school whose profiles compare favorably with such previously determined standardized or proprietary cognitive behavioral profile for intrinsically motivated persons within the profession.

The school or agency monitors the academic and social interactive performance of students whose profiles fit the cognitive behavioral profile of intrinsically motivated people in the profession, which was as created by the school or agency as noted above, and also monitors the academic and social interactive performance of the remaining students whose profiles did not fit that of intrinsically motivated people in the profession but who were nevertheless granted admission to the professional school. Twelve months subsequent to graduation, the school or the agency performs a standardized or proprietary customer satisfaction survey, most preferably the Woods Development Institute customer survey version for physicians, of the customers of both those who as admission candidates had tested as intrinsically motivated and those who did not.

The school or agency then compares the customer satisfaction experienced by customers of the now-graduated students who had fit the intrinsically motivated profile to the customer satisfaction experienced by customers of the now-graduated students who had fit the not intrinsically motivated profile. The school or agency next determines if there is a significant difference in satisfaction experienced by customers of the members of the profession who had tested as being intrinsically motivated when they were candidate students prior to becoming members of the profession versus the customers of the members of the profession who had tested as not being intrinsically motivated when they were candidate students prior to becoming members of the profession.

If the school or agency finds the standardized or proprietary cognitive behavioral profile, which it created, to be predictive of high customer satisfaction based on the distinction between the customer satisfaction of the intrinsically motivated member of the profession and the non-intrinsically motivated members of the profession, the school or agency determines that a valid cognitive behavioral profile for the profession has been defined and thereafter uses the same as criteria for accepting/rejecting students for the professional school.

### PROPHETIC EXAMPLE A FOR FIG. 6

A professional school or professional accrediting agency implements a method for evaluating candidates for admission to the professional school and providing a group of intrinsically motivated candidates which, after acceptance and upon graduation the school from such school will, as a group of such professionals, have substantially statistically lower probability of being charged with professional malpractice. The implementation of the method also provides guidance for selected members of the group of accepted candidates as needed to further lower their probability of being so-charged with professional malpractice subsequent to graduation.

The method commences with the school identifying a sufficient number of practicing individuals in the profession of interest which fit the accepted definition of positive deviants in the profession. A positive deviant is one in the profession whose exceptional behavior and/or practices enable them to achieve superior results relative to others in the profession working with the same resources. The school needs to develop a standardized or proprietary cognitive behavioral profile for positive deviants in the profession of interest in order to implement the method and so proceeds to subject the identified positive deviant individuals practicing the profession to standardized or proprietary cognitive behavioral profiling, as described above in Prophetic Example D for FIG. 2.

Using the results of the standardized or proprietary cognitive behavioral profiling, the school documents and establishes a standardized or proprietary cognitive behavioral profile for positive deviants in the profession of interest. The school then proceeds to create a standardized or proprietary cognitive behavioral profile of those who are intrinsically motivated positive deviant persons within the profession by computer-based analysis of the results for identified intrinsically motivated individuals within the sampled positive deviant population of those in the profession of interest and the results of the standardized or proprietary cognitive behavioral profiling of the positive deviants. The school then proceeds by administering, preferably via the Internet, a standardized or proprietary cognitive behavioral profiling instrument, as described above in Prophetic Example D for FIG. 2, to student candidates for the professional school. The school then compares each student's resulting profile to the previously determined standardized or proprietary cognitive behavioral profile for intrinsically motivated persons within the profession and admits those student candidates to the school whose profiles compare favorably with such previously determined standardized or proprietary cognitive behavioral profile for intrinsically motivated persons within the profession.

The school or agency monitors the academic and social interactive performance of students whose profiles fit the cognitive behavioral profile of intrinsically motivated people in the profession, which was as created by the school or agency as noted above, and also monitors the academic and social interactive performance of the remaining students whose profiles did not fit that of intrinsically motivated people in the profession but who were nevertheless granted admission to the professional school. Twelve months subsequent to graduation, the school or the agency performs a standardized or proprietary customer satisfaction survey, as described above in Prophetic Example D for FIG. 2, most preferably the Woods Development Institute customer survey, of the customers of both those who as admission candidates had tested as intrinsically motivated and those who did not.

The school or agency then compares the customer satisfaction experienced by customers of the now-graduated students who had fit the intrinsically motivated profile to the customer satisfaction experienced by customers of the now-graduated students who had fit the not intrinsically motivated profile. The school or agency next determines if there is a significant difference in satisfaction experienced by customers of the members of the profession who had tested as being intrinsically motivated when they were candidate students prior to becoming members of the profession versus the customers of the members of the profession who had tested as not being intrinsically motivated when they were candidate students prior to becoming members of the profession.

If the school or agency finds the standardized or proprietary cognitive behavioral profile, which it created, to be predictive of high customer satisfaction based on the distinction between the customer satisfaction of the intrinsically motivated member of the profession and the non-intrinsically motivated members of the profession, the school or agency determines that a valid cognitive behavioral profile for the profession has been defined and thereafter uses the same as criteria for accepting/rejecting students for the professional school.

It is further to be understood that the while the invention has been disclosed principally discussing determining average levels of customer satisfaction by averaging determined satisfaction levels of responding customers for a given candidate, in certain instances average of level of customer satisfaction may not be the appropriate parameter. For example, older customers may be less easily satisfied by the candidate but may also be less likely than the younger customer to bring an action for professional malpractice. It is within the purview of the invention to apply algorithms to account for such differences in ease of satisfaction among respective age groups, demographic groups, geographic groups and the like and also to apply algorithms to adjust for the ease of satisfaction among, for example in the case of physicians, general practitioners, internists, gastrointerologists, neurosurgeons, neurologists, psychiatrists, dentists, oral surgeons, periodontists, endodontists, dermatologists, orthopedic surgeons, allergists and other professional specialties.

While the invention has been described principally with respect to assembling and maintaining groups of physicians having low probability of being charged with professional malpractice, other of the examples presented hereinabove apply to other professions, student bodies and the like. The principles of the invention have wide ranges of applicability including to the legal profession, the teaching profession, sales and marketing personnel, government employees such as civil servants, stock brokers, etc.

The screens, tables, figures, etc. presented herein are all been prepared for use of the invention with the medical profession. It is to be understood that when the invention is used with professionals from other professions, appropriate modifications may be needed to the text appearing on the screens figures and the like.

This being said, the immediate application of the invention is most desirably to the medical profession in view of the malpractice crisis in the United States of America.

What is claimed is:

1) A method for electronically via the Internet assembling and electronically via the Internet dynamically maintaining a group of professionals having relatively low probability of being charged with professional malpractice, comprising the steps of:
a) for each candidate member of the group to be assembled, using a standardized customer satisfaction survey, electronically via the Internet monitoring customer satisfaction for such candidate member of the group over a period of time to evaluate and document the predominant satisfaction that the candidate group member is achieving with patients;
b) categorizing the predominant satisfaction for such candidate group member over time as high or low;
c) if the candidate was evaluated to have a high predominant satisfaction over the time period, admitting the candidate to the group and thereafter periodically repeatedly electronically via the Internet monitoring customer satisfaction for such candidate and maintaining the candidate in the group so long as the candidate evaluates as having high predominate satisfaction.

2) A method for electronically via the Internet screening candidates for admission to professional school to produce an incoming class having minimal risk of incurring professional liability upon graduation from school and undertaking professional practice, comprising the steps of:
a) for each candidate student otherwise exhibiting credentials appearing to be acceptable for admission to the professional school of interest, electronically via the Internet subjecting the candidate to standardized cogitative/behavioral profiling to identify the candidate's cogitative/behavioral/motivational profile;
b) if a high intrinsic motivational profile towards such professional study and satisfaction of customers for the profession's services was found and confirmed by the standardized cogitative/behavioral profiling, then
i) admitting the candidate to the professional school; otherwise.
ii) conditionally admitting the candidate to the professional school and thereafter
(1) requiring the candidate to undergo behavioral modification risk training electronically via the Internet or leadership education electronically via the Internet;
c) upon successful completion of the behavioral modification risk training or the leadership education, lifting the condition on the candidate's admission to the professional school.

3) A method for electronically via the Internet assembling and electronically via the Internet dynamically maintaining a group of professionals having relatively low probability of being charged with professional malpractice, comprising the steps of:
a) for each candidate member of the group to be assembled, using a standardized customer satisfaction survey, electronically via the Internet monitoring customer satisfaction for such candidate member of the group over a period of time to evaluate and document the satisfaction that the candidate group member is achieving with customers;
b) categorizing the customer satisfaction for such candidate member over time as acceptably high or otherwise unacceptably low.
c) if the candidate was evaluated to have high customer satisfaction over the time period, admitting the candidate to the group and thereafter
i) periodically repeatedly electronically via the Internet monitoring customer satisfaction for such candidate and
(1) maintaining the candidate in the group so long as the candidate evaluates as having high customer satisfaction; but
(2) identifying the candidate as possibly becoming an unacceptably high liability risk whenever the candidate evaluates electronically via the Internet as having low customer satisfaction and thereafter proceeding to step (e) below;
d) if the candidate evaluates electronically via the Internet as having low customer satisfaction over time, identifying the candidate as potentially representing an unacceptably high liability risk and being unqualified, based on present information, for inclusion in the group having relatively low probability of being charged with professional malpractice;
e) requiring the candidate either to
i) submit to standardized cognitive behavioral profiling electronically via the Internet to identify the candidate's cognitive/behavioral profile; or
ii) go to either behavioral modification training electronically via the Internet or leadership education electronically via the Internet and to attend the same electronically via the Internet for such time until the forward-going customer satisfaction data for such candidate reflect a low-risk profile;
f) for candidates submitting to standardized cognitive behavioral profiling,
i) if the candidate is determined to have a low-risk profile, admit or re-admit the candidate into the group and continue monitoring electronically via the Internet for customer satisfaction by the admittee;
ii) if the candidate was determined to have a high-risk profile, providing the candidate with the option to undergo behavioral modification training electronically via the Internet and/or leadership education electronically via the Internet and to attend the same electronically via the Internet for such time until the forward-going customer satisfaction data for such candidate reflect a low-risk profile but rejecting for membership in the group a candidate given such option who elects to forego the same;
iii) monitoring such candidate with a previously determined high-risk profile and having undergone behavioral modification training and/or leadership education, for such time until the forward-going customer satisfaction data for such candidate reflects a low-risk profile for customer satisfaction as such candidate continues professional practice until such time as forward-going high customer satisfaction data reflects a low risk profile and thereafter admitting/readmitting the candidate into the group.

4) A method for evaluating electronically via the Internet risk attendant to retaining an employee, an insured or an at risk client, comprising the steps of:
a) using a standardized customer satisfaction survey, electronically via the Internet monitoring customer satisfaction for such employee, insured or at risk client over a period of time to evaluate and document satisfaction the employee, insured or at risk client is achieving with customers;
b) categorizing customer satisfaction with such employee, insured or at risk client over time as acceptably high or otherwise unacceptably low;
c) if the employee, insured or at risk client has high customer satisfaction over the time period, categorizing such employee, insured or at risk client as being a low liability risk and thereafter;
i) periodically repeatedly electronically via the Internet monitoring customer satisfaction for such employee, insured or at risk client, and
(1) continuing to categorize the employee, insured or at risk client as being a low liability risk for so long as the employee, insured or at risk client evaluates as having high customer satisfaction; but
(2) identifying the employee, insured or at risk client as possibly representing a high liability risk whenever the employee, insured or at risk client evaluates as having low customer satisfaction and thereafter proceeding to step (e) below;
d) if the employee, insured or at risk client was evaluated electronically via the Internet to have a low customer satisfaction over time in step (b), identifying the employee, insured or at risk client as potentially representing a high liability risk and requiring the candidate either
i) to submit to standardized cogitative/behavioral profiling electronically via the Internet to identify the employee's, insured's or at risk client's cognitive/behavioral profile; or
ii) go to either behavioral modification training electronically via the Internet or leadership education electronically via the Internet and to attend the same electronically via the Internet for such time until the forward-going customer satisfaction data for such employee, insured or at risk client reflects a low-risk profile;
e) for employees, insureds and at risk clients submitting to standardized cogitative/behavioral profiling,
i) if the employee, insured or at risk client is determined to have a low-risk cognitive behavioral profile, categorize/re-categorize the employee, insured or at risk client as low risk and continue monitoring for customer satisfaction by such employee, insured or at risk client;
ii) if the employee, insured or at risk client was determined to have a high-risk cognitive behavioral profile, requiring the employee, insured or at risk client to undergo behavioral modification training and/or leadership education and to attend the same for such time until the forward-going customer satisfaction data for such employee, insured or at risk client reach a desired level reflecting a low-risk profile but rejecting an employee, insured or at risk client given such option who elects to forego the same;
iii) monitoring electronically via the Internet the employee, insured or high risk client with a previously determined high-risk cognitive behavioral profile and having undergone behavioral modification training and/or leadership education for such time until the forward-going customer satisfaction data for such employee, insured or high risk client reflects a low-risk profile, as such employee, insured or high risk client continues in professional practice until such time as the forward-going high customer satisfaction data reflects a low risk profile and thereafter categorizing/recategorizing the employee, insured or high risk client as being of acceptably low risk.

5) A method for electronically via the Internet defining a cognitive behavioral profile predictive of risk according to institutionally predefined parameters, comprising the steps of:
a) defining a target population of interest to said institution;
b) identifying within the target population of interest, mutually exclusive groups of high risk and low risk individuals according to said institutionally predefined parameters;
c) causing the individuals in said high and low risk groups from said target population to undergo standardized cognitive behavioral profiling evaluation electronically via the Internet to delineate and document cognitive behavioral group profiles of the institutionally defined high risk and low risk groups from the target population of interest;
d) from the target population of interest, randomly selecting a group of sufficient number that selection of some individuals from both of the institutionally defined high and the low risk groups is statistically assured;
e) causing the individuals in the randomly selected group to undergo standardized cognitive behavioral profiling evaluation electronically via the Internet;
f) dividing, according to their profiles resulting from the standardized cognitive behavioral profiling evaluation, the evaluated individuals in the randomly selected group into second high and low risk groups respectively meeting the standardized cognitive behavioral profiles of the institutionally defined mutually exclusive groups of high risk and low risk individuals;
g) individually checking the members of the second high and low risk groups to determine if they were in one of the mutually exclusive groups of institutionally defined high risk and low risk individuals of step (b) and for those individuals who were in either one of those groups, checking that the standardized cognitive behavioral profile for that individual meets/matches the standardized cognitive behavioral profiles for the appropriate one of said institutionally defined high and low risk groups;
h) statistically verifying/correlating the standardized cognitive behavioral profiles for the members of the second high and low risk groups with the standardized cognitive behavioral profiles for the appropriate one of the institutionally defined high and low risk groups [to determine the likelihood/probability that a given individual with a given standardized cognitive behavioral profile is/is not within either of the institutionally defined high or low risk categories] thereby to define a confidence level associated with assigning a given individual to one of the institutionally defined high or low risk categories based on that individual's standardized cognitive behavioral profile.

6) A method for electronically via the Internet identifying acceptable and unacceptable liability risk in individuals in a target population for new or to renew professional liability insurance and instituting corrective/remedial training for those individuals identified as manifesting unacceptable liability risk in such target population, comprising the steps of:
a) obtaining a standardized cognitive behavioral profile electronically via the Internet for an individual of interest from the target population;
b) comparing the individual's standardized cognitive behavioral profile to previously obtained ranges of such profiles for persons of acceptably low and unacceptably high risks;
c) identifying the individual as being of acceptable liability risk if the individual's standardized cognitive behavioral profile is within the range for persons of acceptably low risk, but as being of only conditional acceptability if the individual's standardized cognitive/behavioral profile is within the range for persons of high risk;
d) for an individual identified as being of acceptable low risk, approving professional liability insurance coverage for that individual and monitoring electronically via the Internet forward going customer satisfaction for that individual using a selected standardized customer satisfaction survey;
e) for an individual identified as being of unacceptably high risk,
i) conditionally approving professional liability insurance coverage for that individual on the condition the individual enter electronically via the Internet and complete a behavioral modification training or leadership education program with demonstrated improvement over the one year duration of the program, or the conditionally approved professional liability insurance coverage will be cancelled;
ii) once the individual has completed either the behavior modification training electronically via the Internet or the leadership education program electronically via the Internet and has demonstrated improvement to a required extent, removing the condition on the approval of the professional liability insurance and electronically via the Internet monitoring forward going customer satisfaction for that individual using the selected standardized customer satisfaction survey.

7) A method for electronically via the Internet identifying acceptable and unacceptable risk in individual current employees or clients in a captive target population for insurance and/or other benefits and instituting corrective/remedial training for those individuals identified as manifesting unacceptable risk in such target population, comprising the steps of:
a) electronically via the Internet obtaining a standardized cognitive/behavioral profile for an individual of interest from the target population;
b) comparing the individual's standardized cognitive/behavioral profile to previously obtained ranges of profiles for persons of acceptably low and unacceptably high risks;
c) identifying the individual as being an acceptable risk if the individual's standardized cognitive/behavioral profile is within the range for persons of acceptably low risk, but as being an unacceptable risk if the individual's standardized cognitive/behavioral profile is within the range for persons of high risk
d) for an individual identified as being of acceptable low risk, approving continued insurance and/or other benefit coverage for that individual and electronically via the Internet monitoring forward going customer satisfaction for that individual using a selected standardized customer satisfaction survey;
e) for an individual identified as being of unacceptably high risk,
i) conditionally approving continuation of such insurance and other benefit coverage for that individual on the condition of the individual electronically via the Internet entering and completing a behavioral modification training or leadership education program with demonstrated improvement over the one year duration of the program or the approved insurance and benefit coverage will be cancelled;
ii) removing the condition on the approval of the insurance and benefit coverage and monitoring forward going customer satisfaction for that individual using the selected standardized customer satisfaction survey.

8) A method for electronically via the Internet evaluating candidates for admission to professional school and providing a group of accepted intrinsically motivated candidates which upon graduation from such school will, as a group of such professionals, have substantially statistically lower probability of being charged with professional malpractice, and providing guidance for the selected members of the group of accepted candidates as needed to further lower their probability of being so-charged subsequent to graduation, comprising the steps of:
a) identifying a sufficient number of practicing individuals in the profession of interest fitting the popularly accepted definition of positive deviants as being those whose exceptional behavior and/or practices enable them to achieve superior results relative to others in the profession working with the same resources to develop a standardized cognitive behavioral profile for positive deviants in the profession of interest;
b) electronically via the Internet subjecting such identified positive deviant individuals to standardized cognitive behavioral profiling;
c) using the results from step “b”, documenting a standardized cognitive behavioral profile for positive deviants in the profession of interest;
d) creating a standardized cognitive behavioral profile of those who are intrinsically motivated positive deviant persons within the profession by analysis of the identified individuals and the results of the standard cognitive behavioral profiling of the positive deviants;
e) electronically via the Internet administering a standardized cognitive behavioral profiling instrument to student candidates for professional school and comparing each student's resulting profile to the previously determined standardized cognitive behavioral profile for intrinsically motivated within the profession;
f) electronically via the Internet monitoring the academic and social interactive performance of students whose profiles fit the cognitive behavioral profile of intrinsically motivated people in the profession, as created in step “d” above, and the academic and social interactive performance of the remaining students whose profiles did not fit that of intrinsically motivated people in the profession;
g) twelve months subsequent to graduation, perform a standardized customer satisfaction survey electronically via the Internet of the customers of both those who as students had tested as intrinsically motivated and those who did not;
h) comparing the customer satisfaction experienced by customers of the students who had fit the intrinsically motivated profile to the customer satisfaction experienced by customers of the students who had fit the not intrinsically motivated profile;
i) determining if there is a significant difference in satisfaction experienced by customers of the intrinsically motivated members of the profession versus the customers of the members of the profession determined to be not intrinsically motivated;
j) if the standardized cognitive behavioral profile created in step “d” is found to be predictive of high customer satisfaction based on preceding step “i”, determining that a valid standardized cognitive behavioral profile for the profession has been defined and thereafter using the same as criteria for accepting/rejecting students for the professional school.

9) A method for electronically identifying and dynamically maintaining a group of professionals having relatively low probability of being charged with professional malpractice, comprising the steps of:
a) for each candidate member of the group to be assembled, eliciting customer satisfaction for such candidate by sequentially electronically presenting separately to an individual customer of such candidate by telecommunicatively transmitting from a remote locale for display to such customer on a video screen a series of statements concerning the perceptions of the customer regarding the candidate and service provided by the candidate to the customer, with each statement being accompanied by a set of permissible responses to the statement;
b) electronically inducing the customer to select one of the permissible responses to each of the series of statements by prompting the customer with a graphical and/or audible signal transmitted from said remote location and directing the customer to select one of the permissible responses by tactile contact with the video screen and/or manual manipulation of an input device;
c) electronically receiving and collecting at said remote locale the selected response to each of the statements given by a customer furnishing a response for a given candidate;
d) repeating steps “a” through “c” for each of a selected number of customers for the candidate member of the group;
e) electronically assembling the collected responses in a central database at said remote locale;
f) electronically processing the responses for each of the responding customers for a given candidate member of the group to determine a level of satisfaction of each responding customer of such candidate;
g) electronically determining an average level of customer satisfaction for the candidate by averaging the determined satisfaction levels of the responding customers for the candidate;
h) collecting customer satisfaction data and other parameters affecting customer satisfaction such as professional specialty, geographic locale; political subdivision locale, number of professional associates in a practice group and electronically statistically processing the same to develop a database of customer satisfaction criteria;
i) electronically selecting a customer satisfaction criterion for the candidate from the database based on factors such as the professional specialty of the candidate, the geographic locale of the candidate's practice; the political subdivision locale of the candidate's practice, the number of professional associates the candidate has, and the like;
j) electronically comparing the determined average level of satisfaction for a given candidate to the selected criteria;
k) repeating steps “a” through “h” for customers of such candidate over a preselected period of time;
l) categorizing the predominant satisfaction for such candidate group member over time as high or low; based on the collected responses from the customers over time;
m) if the candidate has high predominant customer satisfaction over the time period, admitting the candidate to the group and thereafter periodically repeatedly monitoring customer satisfaction for such candidate by repeatedly performing steps “a” though “h” and maintaining the candidate in the group so long as the candidate evaluates as having high predominate customer satisfaction.
n) If the candidate has low predominant customer satisfaction over the time period, preparing a validated personality profile for the candidate by
i) for such candidate member of the group, sequentially electronically presenting separately to such candidate by telecommunicatively transmitting from a remote locale for display to such candidate on a video screen a series of statements concerning the self-perceptions of the candidate, with each statement being accompanied by a set of permissible responses to the statement;
ii) electronically inducing the candidate to select one of the permissible responses to each of the series of statements by prompting the candidate with a graphical and/or audible signal transmitted from said remote location and directing the candidate to select one of the permissible responses by tactile contact with the video screen and/or manual manipulation of an input device;
iii) electronically receiving and collecting at said remote locale the selected response to each of the statements given by said candidate
iv) establishing a personality profile for the candidate developed from the candidate's responses to the successively presented statements concerning the self-perceptions of the candidate;
v) comparing the personality profile developed for the candidate to profiles for successful people in the candidate's profession and determining from said comparison whether the candidate's profile closely matches that of those of persons who have experienced success in the profession, in which case the candidate is identified as being at low risk of being charged with malpractice and is admitted to the group, or whether the candidates personality profile deviates substantially from those of persons who have experienced success in the profession, in which case the candidate is identified as being at unacceptable high risk of being charged with malpractice and is denied admission to the group;
vi) providing the candidate denied admission to the group with the option to undergo behavioral modification training or leadership training for possible remediation of the candidate as a possible path to admission to the group;
vii) terminating consideration of the candidate for admission into the group if the candidate opts to refrain participating in at least one of the behavioral modification training or leadership training;
o) for such candidate member of the group, providing either behavior modification training or leadership training or both by interactively sequentially electronically presenting to such candidate by telecommunicatively transmitting from a remote locale for display to such candidate on a video screen of a remote computer terminal lesson materials, interactive behavioral modification and/or leadership training exercises, readings, assignments, quizzes and examinations to periodically measure from a remote locale the progress of the candidate member of the group undergoing such behavior modification training or leadership electronically receiving and collecting at said remote locale the selected response to each of the statements given by said candidate;
p) periodically telecommunicatively examining such candidate as to whether the candidate has effectuated acceptable behavioral modification and/or developed sufficient and acceptable leadership skills relative to predetermined criteria for persons who have been successful in the profession and relative to others in the group as to be included in the group and, in such case admitting the candidate to the group but if not, denying the candidate admission into the group and offering the candidate the opportunity for further behavioral modification training and/or leadership training;
q) for the member of the group having successfully completed behavioral modification training and/or leadership training and having been admitted to the group on such basis, monitoring for continued acceptable behavioral characteristics and leadership traits for such group member by sequentially electronically presenting separately to the group member and individually separately to the group members' professional associates, office staff members, supervisors and others having regular contact with the group member and hence having the opportunity to observe the group member in a variety of professional situations, by generating at a remote locale for display to one of such persons on a video screen a series of statements concerning the perceptions of person regarding the group member's behavioral characteristics and leadership traits, with each statement being accompanied by a set of permissible responses to the statement;
r) electronically inducing the person to select one of the permissible responses to each of the series of statements by prompting the person with a graphical and/or audible signal transmitted from said remote location and directing the person to select one of the permissible responses by tactile contact with the video screen and/or manual manipulation of an input device;
s) electronically receiving and collecting at said remote locale the selected response to each of the statements given by a person furnishing a response for the group member;
t) repeating steps “q” through “s” for each of a selected number of persons for the group member;
u) electronically assembling the collected responses in a central database at said remote locale;
v) electronically processing the responses for each of the responding persons for the group member to determine the perceived behavioral characterizes and leadership traits of the group member as determined by the persons interrogated;
w) electronically comparing the a perceived behavioral characteristic profile and a perceived leadership trait profile for the group member to the selected criteria; and
x) categorizing the a perceived behavioral characteristic profile and a perceived leadership trait profile for such group member over time as satisfactory or unsatisfactory; based on the collected responses from peer persons over time and maintaining or removing the member from the group according to such a perceived behavioral characteristic profile and a perceived leadership trait profile.
